(19) United States
(12) Patent Application Publication
(10) Pub. No.: US 2015/0186940 A1
(43) Pub. Date: Jul. 2, 2015

(54) Techniques For Generating Advertisements

(71) Applicant: Quixey, Inc., Mountain View, CA (US)

(72) Inventors: Michael Harris, Mountain View, CA (US); James Delli Santi, San Jose, CA (US)

(73) Assignee: Quixey, Inc., Mountain View, CA (US)

(21) Appl. No.: 14/273,902

(22) Filed: May 9, 2014

Related U.S. Application Data
(60) Provisional application No. 61/922,350, filed on Dec. 31, 2013.

(51) Int. Cl. G06Q 30/02; G06F 17/30

(52) U.S. Cl. CPC G06Q 30/0256; G06F 17/30864

(57) ABSTRACT

A method includes receiving a search query from a computing device, performing a search for software applications using the search query, and generating a list of N software applications identified during the search. The method further includes identifying an advertisement record in an advertisement data store. The advertisement data store includes one or more advertisement records. Each advertisement record lists a sponsored application associated with the advertisement record and includes advertisement content for the sponsored application. Identifying the advertisement record includes determining that the sponsored application of the identified advertisement record is similar to at least one of the N software applications identified during the search. Additionally, the method includes generating an advertisement for the sponsored application based on the advertisement content in the identified advertisement record and transmitting the list of the N software applications and the generated advertisement to the computing device.

### CROSS-REFERENCE TO RELATED APPLICATION

This application claims the benefit of U.S. Provisional Application No. 61/922,350 filed Dec. 31, 2013, which is hereby incorporated by reference in its entirety.

### TECHNICAL FIELD

The disclosure generally relates to the field of search, and more particularly to techniques for generating advertisements for search results.

### BACKGROUND

In recent years, use of computers, smartphones, and other Internet-connected devices has grown exponentially. Correspondingly, the number of available software applications for such devices has also grown. Today, many diverse applications can be accessed on any number of different devices, including, but not limited to, smartphones, personal computers, automobiles, and televisions. These diverse applications can include business driven applications, games, educational applications, news applications, shopping applications, messaging applications, media streaming applications, social networking applications, and so much more. Application developers advertise their diverse applications across a variety of different computing platforms in order to promote installation and use of their applications. In order to efficiently advertise their applications to users, the application developers may advertise to a targeted audience, which may include specific groups of users or user device types.

### SUMMARY

In one example, a method includes receiving a search query from a computing device, performing a search for software applications using the search query, and generating a list of N software applications identified during the search. In this example, N is an integer greater than or equal to 1. The method further includes identifying an advertisement record in an advertisement data store. In this example, the advertisement data store includes one or more advertisement records. Each advertisement record lists a sponsored application associated with the advertisement record and includes advertisement content for the sponsored application. Also in this example, identifying the advertisement record includes determining that the sponsored application of the identified advertisement record is similar to at least one of the N software applications identified during the search. The method also includes generating an advertisement for the sponsored application based on the advertisement content in the identified advertisement record, and transmitting the list of the N software applications and the generated advertisement to the computing device.

In another example, a system includes an advertisement data store that includes one or more advertisement records. In this example, each advertisement record lists a sponsored application associated with the advertisement record and includes advertisement content for the sponsored application. The system further includes one or more computing devices configured to receive a search query from a user computing device, perform a search for software applications using the search query, and generate a list of N software applications identified during the search. In this example, N is an integer greater than or equal to 1. The one or more computing devices are further configured to identify an advertisement record in the advertisement data store by determining that the sponsored application of the identified advertisement record is similar to at least one of the N software applications identified during the search. The one or more computing devices are also configured to generate an advertisement for the sponsored application based on the advertisement content in the identified advertisement record, and transmit the list of the N software applications and the generated advertisement to the user computing device.

In another example, a non-transitory computer-readable storage medium includes instructions that cause one or more computing devices to receive a search query from a computing device, perform a search for software applications using the search query, and generate a list of N software applications identified during the search. In this example, N is an integer greater than or equal to 1. The instructions further cause the one or more computing devices to identify an advertisement record in an advertisement data store. In this example, the advertisement data store includes one or more advertisement records. Each advertisement record lists a sponsored application associated with the advertisement record and includes advertisement content for the sponsored application. Also in this example, the instructions that cause the one or more computing devices to identify the advertisement record include instructions that cause the one or more computing devices to determine that the sponsored application of the identified advertisement record is similar to at least one of the N software applications identified during the search. The instructions included in the storage medium also cause the one or more computing devices to generate an advertisement for the sponsored application based on the advertisement content in the identified advertisement record, and transmit the list of the N software applications and the generated advertisement to the computing device.

In another example, a method includes receiving a search query from a computing device, performing a search for software applications using the search query, and generating a list of N software applications identified during the search. In this example, N is an integer greater than or equal to 1. The method further includes identifying an advertisement record in an advertisement data store. In this example, the advertisement data store includes one or more advertisement records. Each advertisement record lists a sponsored application associated with the advertisement record and includes advertisement content for the sponsored application. The method also includes determining whether the sponsored application of the identified advertisement record is similar to at least one of the N software applications identified during the search. When the sponsored application is similar to at least one of the N software applications, the method includes generating an advertisement for the sponsored application based on the advertisement content in the identified advertisement record, and transmitting the list of the N software applications and the generated advertisement to the computing device.

### BRIEF DESCRIPTION OF DRAWINGS

The details of one or more examples are set forth in the accompanying drawings and the description below. Other features, objects, and advantages will be apparent from the description and drawings, and from the claims.

FIG. 1 is a schematic illustrating an example environment including a search system and an advertisement system.

FIG. 2 is a functional block diagram of an example application search module.

FIGS. 3A-3B are schematics illustrating example application records.

FIG. 4 is a flow diagram illustrating an example set of operations for a method for performing an application search.

FIG. 5 is a functional block diagram that illustrates example interactions between a user device, a search system, and an advertisement system.

FIGS. 6A-6B are schematics illustrating example advertisement records.

FIG. 7 is a schematic illustrating an example graphical user interface presented by a user device.

FIG. 8 is a functional block diagram of an example advertisement generation module.

FIG. 9 is a flow diagram illustrating an example set of operations for a method for generating search results and an advertisement for the search results.

FIG. 10 is a functional block diagram of another example advertisement generation module.

FIG. 11 is a flow diagram illustrating an example set of operations for a method for generating an advertisement for a sponsored application.

FIG. 12 is a functional block diagram of another example advertisement generation module.

### DETAILED DESCRIPTION

The figures and the following description relate to example implementations by way of illustration only. It should be noted that from the following discussion, alternative implementations of the structures and methods disclosed herein will be readily recognized as viable alternatives that may be employed without departing from the scope of the disclosure.

The present disclosure relates to searching for software applications (i.e., “applications”) and generating advertisements based on the search results. A search system of the present disclosure receives a search query from a user's computing device (e.g., a mobile computing device). The search system generates search results in response to the received search query. The search results include a list of applications that may be ranked based on a variety of different factors (e.g. relevance of the applications with respect to the search query). The search system transmits the search results in the form of a list of applications to the users computing device. The users computing device presents (e.g., displays) the list of applications to the user so that the user may select one or more of the applications to preview and/or download. In some examples, one or more of the search system and the user's computing device may filter and/or sort the search results using a variety of logic (e.g., so-called “business logic”), predefined filters, and machine learning algorithms prior to the search results being displayed to the user.

An advertisement system of the present disclosure uses the search results to generate one or more advertisements for the user. For example, the advertisement system may generate an advertisement for a sponsored application that is similar to one or more applications in the search results. The advertisement system transmits (e.g., serves) the generated advertisement to the user's computing device. The user's computing device may display the advertisement along with the list of applications included in the search results. The advertisement may include information indicating that the advertisement is a sponsored result. For example, the advertisement may include text indicating that the sponsored application is a “Sponsored Result” or an “Advertisement.”

The search system includes an application data store that the search system may use to generate the search results. In some examples, the application data store is included in one or more storage devices. The application data store includes data associated with a plurality of different applications. The data associated with an application may be referred to herein as an “application record” (e.g., application record 130 of FIG. 3A). The application data store include a plurality of such application records that each include data related to a different application.

An application record may include a variety of different types of data related to an application. An application record may include, without limitation, the name of the application, the name of the developer of the application, a description of the application, one or more categories associated with the application, application statistics (e.g., a number of downloads of the application), keywords associated with the application, reviews associated with the application, the platform(s) (e.g., one or more operating systems) and/or target device(s) of the application, the price of the application, and other information. The application data store may include data for a variety of different applications available on a variety of different operating systems and devices. The search system may retrieve and analyze data from the application data store in order to provide search results.

In some examples, an application record associated with an application may include information that describes or otherwise indicates one or more of the following: 1) one or more functions associated with the application, 2) one or more internal states of the application (e.g., particular screen(s) or user interface(s) within the application), 3) application-related data (e.g., local business data used or provided by the application), 4) data from online sources (e.g., websites or blogs) related to the application, 5) the release date and/or the age of the application, and 6) trustworthiness of the application (e.g., whether the application is designated as “spam,” for example, based on the name of its developer). In some examples, an application record may also include so-called “click data” associated with the corresponding application, as described in greater detail below. In other examples, the click data may be included in another location or data structure.

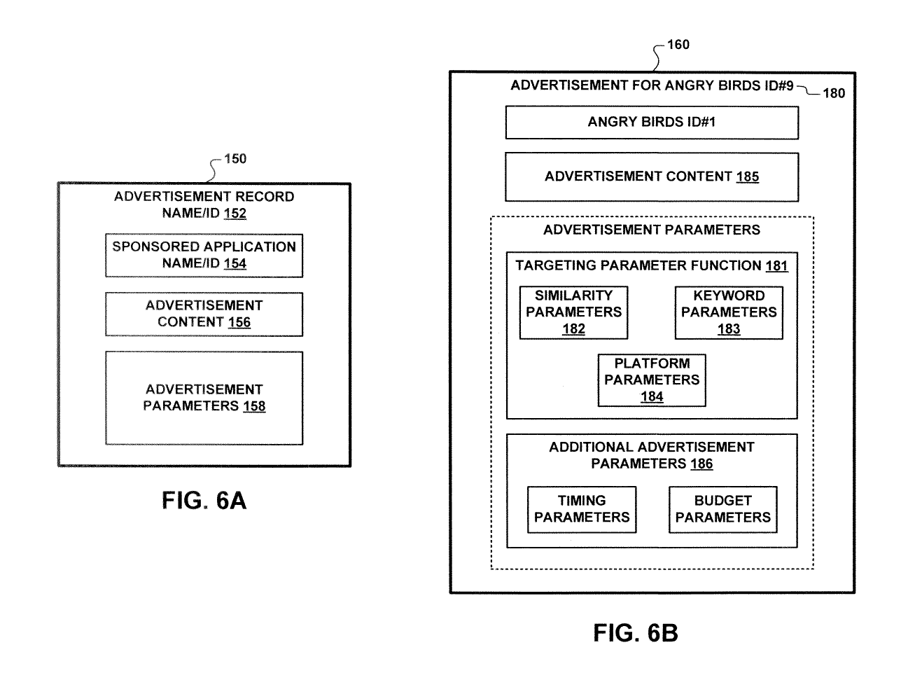

The advertisement system includes an advertisement data store that the advertisement system may use to generate advertisements. In some examples, the advertisement data store is included in one or more storage devices. The advertisement data store includes data associated with a plurality of different advertisements. The data associated with an advertisement may be referred to as an “an advertisement record” (e.g., advertisement record 150 of FIG. 6A). The advertisement data store may include a plurality of advertisement records that each include data for a different advertisement. The advertisement records may be generated by advertisers, by advertisement agencies, or by providers of any of the application search and advertisement generation functionalities described above (i.e., by providers of one or more of the search system and the advertisement system), as some examples.

An advertisement record may include a variety of different types of data related to an advertisement. An advertisement record may include data that identifies the advertisement record. For example, the advertisement record may include an advertisement name and/or advertisement identifier (i.e., an “advertisement ID”) that identifies the advertisement record among the different advertisement records in the advertisement data store.

An advertisement record may also include a sponsored application name and/or sponsored application ID that identifies a sponsored application associated with the advertisement record. A sponsored application may be an application for which an advertiser has paid to have the application displayed to a user. For example, an advertiser may pay for a sponsored application to be advertised along with search results generated by the search system. The advertisement record includes advertisement content used to generate an advertisement for the sponsored application of the advertisement record. For example, advertisement content may include text, images (e.g., icons), animations, and videos associated with the sponsored application. The advertisement (e.g., text and images) for a sponsored application may be displayed along with the list of applications included in the search results on a user's computing device. In some examples, the generated advertisement may include a link that enables the user to purchase the sponsored application from one or more digital distribution platforms (e.g., app stores).

The advertisement record may also include advertisement parameters. Advertisement parameters may define budgets associated with advertising the sponsored application. Advertisement parameters may also define timing parameters associated with advertising the sponsored application, such as start and stop dates for advertising the sponsored application and/or time(s) of day during which the sponsored application is to be advertised, as some examples. Additionally, advertisement parameters may specify user parameters associated with advertising the sponsored application, such as, for example, one or more search query languages for which the sponsored application is to be advertised and/or the number of times a particular advertisement is to be displayed to each user.

Advertisement parameters may also include a variety of different types of targeting parameters. A targeting parameter may refer to a condition that should be satisfied before the advertisement system generates an advertisement. The advertisement system may use targeting parameters in an advertisement record to determine whether to generate an advertisement for the sponsored application of the advertisement record. For example, the advertisement system may generate an advertisement for the sponsored application listed in an advertisement record when one or more targeting parameters of the advertisement record are satisfied. Example types of targeting parameters may include, but are not limited to, similarity targeting parameters, keyword targeting parameters, and platform targeting parameters.

Additional advertisement (e.g. target) parameters may include, for example, time-slotting, day-parting, category, geographical, contextual, demographic, behavioral, platform, device, and partner parameters. In other words, in some examples, the advertisement system may generate an advertisement for a sponsored application in one or more of the following instances: 1) during one or more designated time slots, 2) on one or more given days or during one or more specified portions thereof, 3) for one or more particular categories of applications included in the search results, 4) for users located in one or more geographic locations or regions, 5) based on context (e.g., for one or more states of the user's computing device, the search system, and/or the advertisement system), 6) for one or more specified user types or groups, 7) when one or more user behaviors are detected (e.g., when the user interacts with the user's computing device in a particular manner), 8) for one or more platform (e.g., operating system) and device types associated with the user's computing device or the applications included in the search results, and 9) when one or more specified partner computing systems are used (e.g., when the user's computing device communicates with the search system and/or the advertisement system via a designated partner computing system).

An advertisement record may include a targeting parameter function. A targeting parameter function may define which of the targeting parameters of the advertisement record should be satisfied in order to generate an advertisement. In some examples, the targeting parameter function may include a single targeting parameter. In these examples, the advertisement system may generate an advertisement for a sponsored application based on satisfaction of a single targeting parameter, such as a similarity targeting parameter or a keyword targeting parameter. In other examples, the targeting parameter function may include multiple different targeting parameters. In these examples, the advertisement system may generate an advertisement for a sponsored application based on satisfaction of multiple targeting parameters, such as one or more similarity targeting parameters, one or more keyword targeting parameters, and a platform targeting parameter. In scenarios where a targeting parameter function includes multiple targeting parameters, the targeting parameter function may include a Boolean function that includes the multiple targeting parameters.

As described above, the advertisement system may generate an advertisement based on satisfaction of a similarity targeting parameter. In some examples, a similarity targeting parameter may refer to a condition that is satisfied when two applications are similar. For example, a similarity targeting parameter of an advertisement record may be satisfied when the sponsored application of the advertisement record is determined to be similar to one or more of the applications included in the search results.

The advertisement system may determine whether two applications are similar. For example, the advertisement system may determine whether a sponsored application is similar to an application listed in the search results. In some implementations, the advertisement system may determine a similarity score that indicates the amount of similarity between two applications. The advertisement system may determine the similarity score in a variety of ways. In some implementations, the advertisement system may determine a similarity score for two applications based on text matches between the application records of the two applications. The advertisement system may also determine the similarity score based on other parameters, such as a match between categories of the applications.

In other examples, the advertisement system may determine a similarity score for two applications based on click data associated with the applications. Click data associated with two or more applications may refer to information that indicates whether (and, in some cases, how many times) one or more users have previously selected, or “clicked on,” the two or more applications in a manner that indicates that the applications may be similar. As one example, click data may indicate that a user has selected the two or more applications from search results received by the user in response to the user's application search query. As another example, click data may indicate that the user has selected the two or more applications from a list of applications presented to the user, for example, from an application menu that groups applications based on category. In the examples described above, the user selecting each of the two or more applications in a particular setting (i.e., from search results responsive to an application search query, or from a list of applications grouped based on category) may indicate that the two or more applications are similar. Additionally, click data may indicate the number of times one or more users have selected the two or more applications in a given setting. In this example, the one or more users selecting the two or more applications a particular number of times in a given setting may also indicate similarity and/or a degree of similarity among the applications. Accordingly, click data associated with two or more applications, as described in this disclosure, may include information that indicates any of the above-described user actions with respect to the two or more applications.

As previously explained, click data associated with two or more applications may be included within an application record of one or more of the applications, or in another location or data structure. Additionally, in some examples, click data may be referred to as similarity data, and, in some cases, may be included within an application record associated with an application, or within a similarity data store.

The advertisement system may also determine the similarity score for the two applications based on corresponding application record data descriptive or otherwise indicative of functions associated with the applications, internal states of the applications, data used or provided by the applications, online source data related to the applications, release dates and/or ages of the applications, or trustworthiness of the applications. In general, the advertisement system may determine a similarity score for two applications using any algorithmic combination of data included within application records associated with the applications, or other data related to the applications. The advertisement system may determine that two applications are similar based on a comparison of a similarity score generated based on the two applications to one or more threshold values (e.g., when the similarity score is greater than a threshold similarity score).

In still other examples, the advertisement system may determine that two applications are similar based on any of one or more text matches between application records of the two applications, one or more matches between categories of the applications, and click data associated with the applications. In some examples, the advertisement system may also determine that the two applications are similar based on one or more lookup tables. In other words, in these examples, the advertisement system may determine that the two applications are similar without determining a similarity score for the applications.

The advertisement system of the present disclosure may be configured to generate an advertisement for a sponsored application when similarity targeting parameters of an advertisement record are satisfied. In one example, a similarity targeting parameter included in an advertisement record may indicate that the sponsored application of the advertisement record should be advertised if the sponsored application is similar to one or more of the applications in the search results. In this example, the advertisement system may generate an advertisement for the sponsored application if the advertisement system determines that one or more of the applications in the search results is similar to the sponsored application. In another example, a similarity targeting parameter included in an advertisement record may indicate that the sponsored application of the advertisement record should be advertised if the sponsored application is similar to the highest ranked application in the search results. In this example, the advertisement system may generate an advertisement for the sponsored application if the advertisement system determines that the highest ranked application of the search results is similar to the sponsored application.

Advertisement records may include similarity targeting parameters other than those described above. For example, a similarity targeting parameter included in an advertisement record may indicate that the sponsored application of the advertisement record should be advertised if the sponsored application is similar to multiple applications in the search results. Advertisement records may also include different targeting parameters in addition to similarity targeting parameters. For example, advertisement records may include keyword targeting parameters and/or platform targeting parameters in addition to similarity targeting parameters. In some examples, some of the advertisement records included in the advertisement data store may not include similarity targeting parameters. Instead, some advertisement records may include targeting parameters other than similarity targeting parameters.

As described above, the advertisement system may generate advertisements for sponsored applications that are similar to applications listed in the search results. Generating advertisements in this manner may provide a number of value propositions to an advertiser. In one example, a user may be more likely to preview and/or download a sponsored application that is similar to applications in the search results because the sponsored application may be relevant to the user. In another example, using a similarity targeting parameter may be an easy and effective way for an advertiser to manage advertising in a changing application market in which new applications are added and older applications are removed. For example, once an advertiser has indicated to the advertisement system to advertise a sponsored application next to similar applications in the search results, the advertiser may not have to spend time readjusting similarity targeting parameters in the future as the application market changes. This may be the case because satisfaction of a similarity targeting parameter is based on applications in the search results, which may reflect those applications that are currently available in the market.

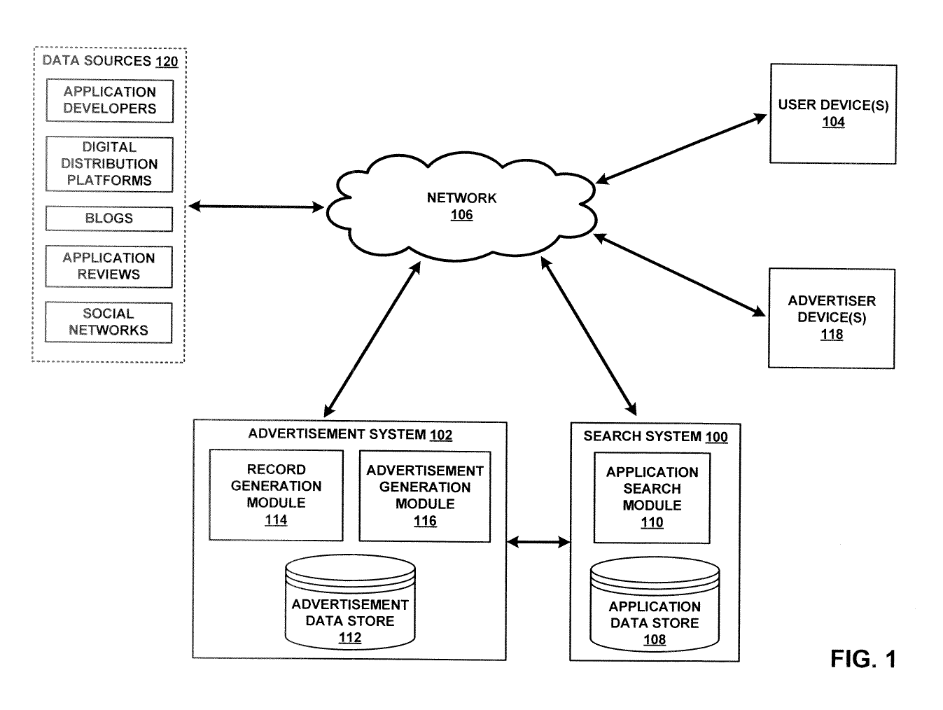

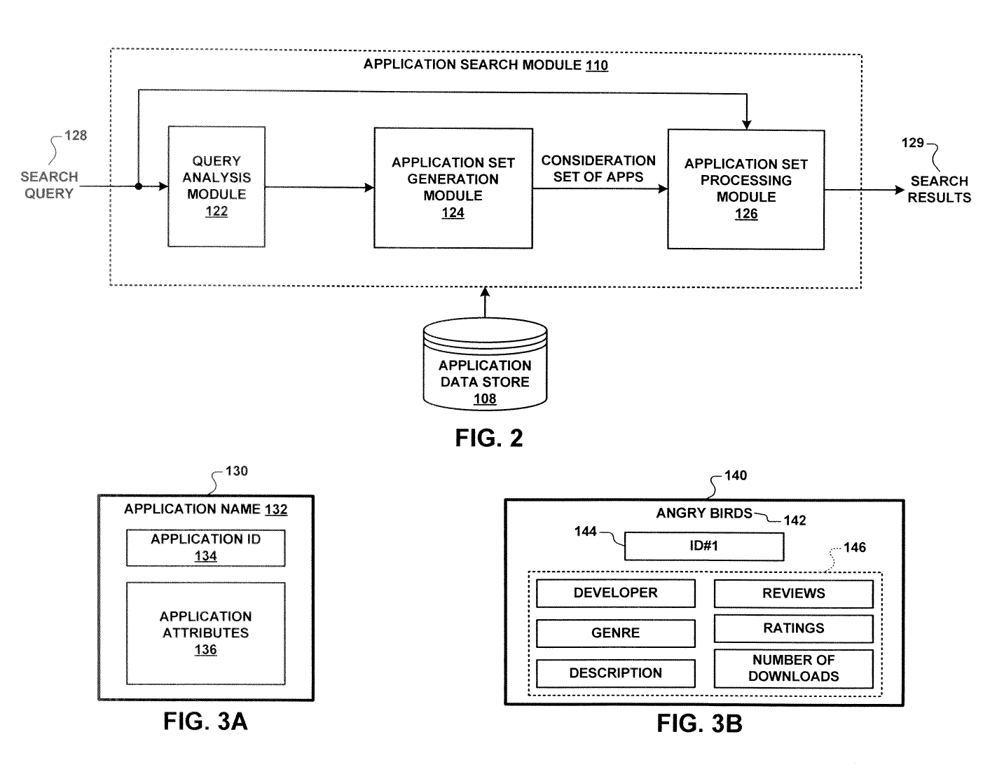

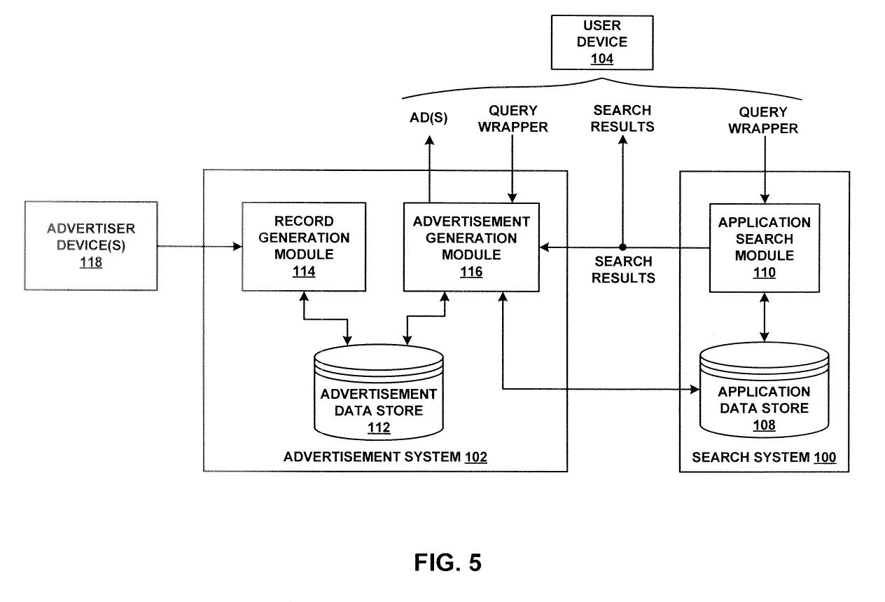

Techniques for performing searches and generating advertisements are described hereinafter with reference to FIGS. 1-12. FIG. 1 illustrates an example environment including a search system and an advertisement system according to the present disclosure. FIGS. 2-4 illustrate techniques for performing application searches. FIGS. 5-12 illustrate techniques for generating advertisements for sponsored applications.

FIG. 1 is a functional block diagram illustrating an example environment including a search system 100 and an advertisement system 102. The search system 100 is configured to perform searches for software applications. The advertisement system 102 is configured to generate advertisements based on the search results. A software application may refer to computer software that causes a computing device to perform a task. In some examples, a software application may be referred to as an “application,” an “app,” or a “program.” Example applications include, but are not limited to, document viewing applications, messaging applications, media streaming applications, social networking applications, and games.

Applications can be executed on a variety of different computing devices. For example, applications can be executed on mobile computing devices such as smart phones, tablets, and wearable computing devices (e.g., headsets and/or watches). Applications can also be executed on other types of computing devices having other form factors such as laptop computers, desktop computers, or other consumer electronic devices. In some examples, applications may be installed on a computing device prior to a user purchasing the computing device. In other examples, the user may download and install applications on the computing device.

The functionality of an application may be accessed on the computing device on which the application is installed. Additionally, or alternatively, the functionality of an application may be accessed via a remote computing device. In some examples, all of an application's functionality is included on the computing device on which the application is installed. These applications may function without communication with other computing devices (e.g., via the Internet). In other examples, an application installed on a computing device may access information from other remote computing devices during operation. For example, a weather application installed on a computing device may access the latest weather information via the Internet and display the accessed weather information to the user through the installed weather application. In still other examples, an application (e.g., a web-based application) may be partially executed by the user's computing device and partially executed by a remote computing device. For example, a web application may be an application that is executed, at least in part, by a web server and accessed by a web browser of the user's computing device. Example web applications may include, but are not limited to, web-based email, online auctions, and online retail sites.

The search system 100 is configured to receive search queries from one or more user device(s) 104 via a network 106. The search system 100 performs a search for applications in response to a received search query. The search may generate a set of search results that includes a list of applications, each of which is associated with a result score that indicates the rank of the application relative to the other applications in the list. The search system 100 may then transmit the search results to the user device 104 that transmitted the search query.

A user device 104 may display the search results to the user and allow the user to select one or more of the applications in the list in order to view information related to the applications and/or download the applications. The applications (e.g., the executable programs) listed in the search results sent to the user may be accessible from (e.g., downloaded from) systems different than the search system 100. Put another way, the search system 100 may store data related to applications that are accessible in locations other than the search system 100. For example, the applications may be accessible from digital distribution platforms configured to distribute the applications. Example digital distribution platforms include, but are not limited to, GOOGLE PLAY®, developed by Google Inc., the APP STORE® developed by Apple Inc. and WINDOWS PHONE STORE developed by Microsoft Corporation. Although the applications listed in the search results may be accessed in locations other than the search system 100, the search system 100 may include applications that are available for download.

The advertisement system 102 uses the search results generated by the search system 100 to generate advertisements. For example, the advertisement system 102 may generate an advertisement for a sponsored application that is similar to one or more applications in the list of applications generated by the search system 100. The advertisement system 102 may transmit (e.g., serve) the advertisement for the sponsored application to the user device 104 that generated the search query so that the user device 104 may display the advertisement along with the set of search results. The user may interact with the advertisement on the user device 104. For example, the user may tap or click the advertisement to download the sponsored application. In some examples, the user may tap the advertisement to be directed to a digital distribution platform that provides the sponsored application for download.

In general, the generated advertisement for the sponsored application may be presented to the user via the user device 104 in any of the following forms: 1) as part of a list of one or more applications that are similar to one or more applications included in the search results, 2) as one or more additional or complementary applications relative to one or more applications included in the search results (i.e., as one or more so-called “cross-sells”), 3) as one or more applications that are considered to provide improved functionality relative to one or more applications included in the search results (i.e., as one or more so-called “up-sells”), and 4) as one or more applications specifically developed or customized for the platform of the user device 104 and/or the user device 104 itself.

In some examples, the advertisement system 102 may generate an advertisement for a sponsored application that belongs to the same family of applications as one or more applications included in the list of applications generated by the search system 100, i.e., the search results. For instance, the sponsored application and the one or more applications included in the search results may be different application versions, or editions, belonging to the same application family. In this example, the sponsored application may be an application version, or edition, that is more optimized for the platform of the user device 104 and/or the user device 104 itself relative to the one or more applications included in the search results. In this manner, by generating the advertisement, the advertisement system 102 may suggest the sponsored application as a potentially better option for the user relative to the one or more applications included in the search results.

The search system 100 includes an application data store 108 and an application search module 110. The application data store 108 includes a variety of different types of data related to different applications. The application data store 108 may include one or more databases, indices (e.g., inverted indices), files, or other data structures which may be used to implement the techniques of the present disclosure. As described herein, the data included in the application data store 108 may include descriptions of applications, statistics related to applications (e.g., download numbers, review numbers, etc.), and other information. The application search module 110 receives a search query and generates search results based on the data included in the application data store 108.

The advertisement system 102 includes an advertisement data store 112, a record generation module 114, and an advertisement generation module 116. The advertisement data store 112 includes data related to a plurality of different advertisements. The data related to an advertisement may be referred to as an advertisement record (e.g., advertisement record 150 of FIG. 6A). Accordingly, the advertisement data store 112 may include a plurality of advertisement records corresponding to different advertisements. The advertisement data store 112 may include one or more databases, indices (e.g., inverted indices), files, or other data structures which may be used to implement the techniques of the present disclosure.

The record generation module 114 generates advertisement records in the advertisement data store 112 based on data received from one or more advertiser device(s) 118. The advertisement generation module 116 may generate advertisements using data from the advertisement data store 112. For example, the advertisement generation module 116 may identify an advertisement record based on satisfaction of a targeting parameter function included in the advertisement record. A targeting parameter function may be satisfied when the targeting parameters of the targeting parameter function and/or the logical relationship (e.g., Boolean function) specified by the targeting parameter function are satisfied. The advertisement generation module 116 may then generate an advertisement based on data included in the identified advertisement record. The advertisement generation module 116 may transmit (e.g., serve) the generated advertisement to the user device 104 that provided the search query.

The search system 100 and the advertisement system 102 may communicate with the user device(s) 104, data sources 120, and advertiser device(s) 118 via the network 106. Examples of the user devices 104, the data sources 120, the advertiser device(s) 118, and the network 106 are now described in turn.

User devices 104 can be any computing devices that are capable of providing search queries to the search system 100. User devices 104 include, but are not limited to, smart phones, tablet computers, laptop computers, and desktop computers. User devices 104 may also include other computing devices having other form factors, such as computing devices included in vehicles, gaming devices, televisions, or other appliances (e.g., networked home automation devices).

The user devices 104 may use a variety of different operating systems. In an example where a user device 104 is a mobile device, the user device 104 may run an operating system including, but not limited to, ANDROID® developed by Google Inc., IOS® developed by Apple Inc., or WINDOWS PHONE® developed by Microsoft Corporation. In an example where a user device 104 is a laptop or desktop computing device, the user device 104 may run an operating system including, but not limited to, MICROSOFT WINDOWS® developed by Microsoft Corporation, MAC OS® developed by Apple Inc., or LINUX® (LINUX® is the registered trademark of Linus Torvalds in the U.S. and other countries). User devices 104 may also access the search system 100 while running operating systems other than those operating systems described above, whether presently available or developed in the future.

User devices 104 can communicate with the search system 100 via the network 106. In some examples, a user device 104 may communicate with the search system 100 using an application installed on the user device 104. In general, a user device 104 may communicate with the search system 100 using any application that can transmit search queries to the search system 100. In some examples, a user device 104 may run an application that is dedicated to interfacing with the search system 100, such as an application dedicated to application searches. In some examples, a user device 104 may communicate with the search system 100 using a more general application, such as a web-browser application. The application may display a search field on a graphical user interface (GUI) in which the user may enter search queries. The user may enter a search query using a touchscreen or physical keyboard, a speech-to-text program, or other form of user input.

A search query entered into a GUI on a user device 104 may include words, numbers, and/or symbols. In general, a search query may be a request for information retrieval (e.g., search results) from the search system 100. For example, a search query may be directed to retrieving a list of applications in implementations where the search system 100 is configured to generate a list of applications as search results. A search query directed to retrieving a list of applications may indicate a user's desire to retrieve applications that have a functionality implicated by the search query.

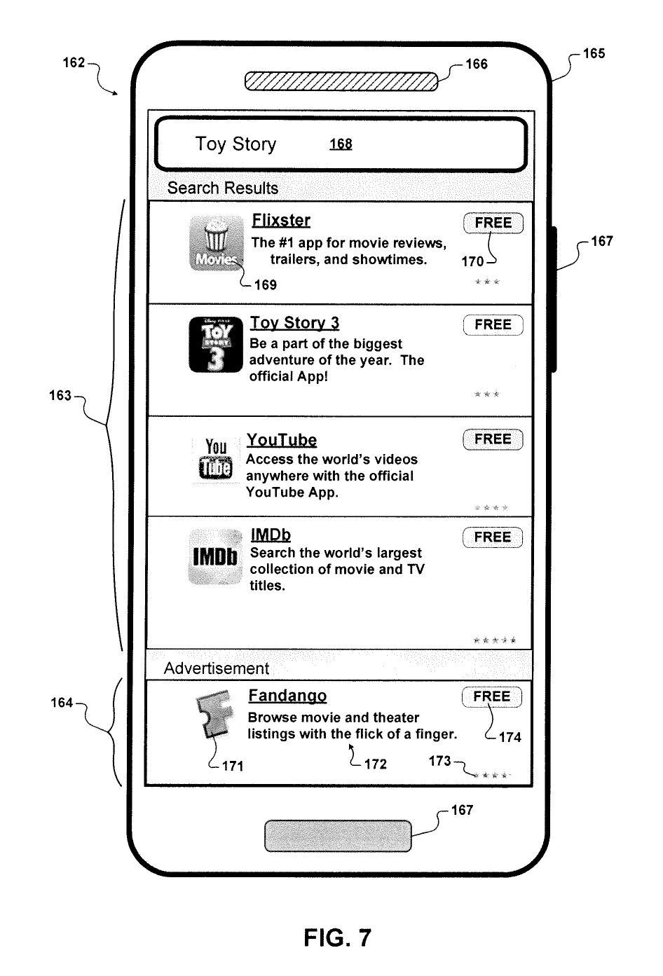

A user device 104 may receive a set of search results from the search system 100 that are responsive to the search query transmitted to the search system 100. The user device 104 may display the search results via the GUI. The application running on the user device 104 may display the search results in the GUI in a variety of different manners, depending on what information is transmitted to the user device 104. In examples where the search results include a list of ranked applications, the search system 100 may transmit the list of applications to the user device 104. In this example, the GUI may display the search results to the user as a list of application names. In some examples, the search system 100, or other computing system, may transmit additional information to the user device 104 including, but not limited to, application ratings, application download statistics, application screenshots, and application descriptions. In these examples, the GUI may display this information along with the list of application names. In some examples, the GUI may display the search results as a list of applications ordered from the top of the screen to the bottom of the screen, such that the list of applications is ordered by descending result scores. In some examples, the search results may be displayed under the search field in which the user entered the search query. An example GUI including search results and a generated advertisement is illustrated and described herein with respect to FIG. 7.

In some examples, user devices 104 may communicate with the search system 100 and the advertisement system 102 via a partner computing system (not illustrated). The partner computing system may be a computing system of a third party that may leverage the search functionality of the search system 100 and the advertising functionality of the advertising system 102. The partner computing system may belong to a company or organization other than that which operates the search system 100 and/or the advertisement system 102. Example third parties which may leverage the functionality of the search system 100 and the advertisement system 102 may include, but are not limited to, internet search providers and wireless communications service providers. The user devices 104 may send search queries to the search system 100 and receive search results via the partner computing system. The user devices 104 may also receive advertisements from the advertisement system 102 via the partner computing system. The partner computing system may provide a user interface to the user devices 104 in some examples and/or modify the search experience provided on the user devices 104.

FIG. 1 illustrates a plurality of data sources 120. The data sources 120 may be sources of data which the search system 100 may use to generate and update the application data store 108. For example, the search system 100 may use the data to update one or more databases, indices, files, or other data structures included in the application data store 108. The search system 100 may generate new application records (e.g., application record 130 of FIG. 3A) and update existing application records based on data retrieved from the data sources 120. Although not illustrated in FIG. 1, the search system 100 may include modules that generate new application records and update existing application records based on the data retrieved from the data sources 120. In some examples, some data included in the application data store 108 may be manually generated.

The data sources 120 may include a variety of different data providers. The data sources 120 may include data from application developers, such as application developers' websites. The data sources 120 may include operators of digital distribution platforms configured to distribute applications to user devices 104. The data sources 120 may also include other websites, such as websites that include web logs (i.e., blogs), application review websites, or other websites including data related to applications. Additionally, the data sources 120 may include social networking sites, such as “FACEBOOK®” by Facebook, Inc. (e.g., Facebook posts) and “TWITTER®” by Twitter Inc. (e.g., text from tweets). The data sources 120 may also include additional types of data sources in addition to the data sources described above. Different data sources may have their own content and update rate.

The search system 100 retrieves data from one or more of the data sources 120. The data retrieved from the data sources 120 can include any type of data related to applications. Examples of data related to applications include, but are not limited to, a name of an application, a description of an application, a substantive review of an application, a quality rating of an application, a developer name, an excerpt from a blog post about an application, a tweet about an application, and one or more images (e.g., icons and/or screenshots) associated with the application. The search system 100 may also retrieve statistical data from the data sources 120. Statistical data may include any numerical data related to an application, such as a number of downloads, download rates (e.g., downloads per month), a number of reviews, and a number of ratings. In some examples, data retrieved from the data sources 120 may include information regarding the functionalities of applications.

The advertiser devices 118 may be computing devices used by advertisers to generate advertisement records. An advertiser may refer to application developers, advertising agencies, or other companies seeking to advertise applications or other products along with search results generated by the search system 100. For example, a developer of an application may wish to advertise their application to users in order to prompt the users to download and/or install the developer's application. The advertiser devices 118 may include, but are not limited to, smart phones, tablet computers, laptop computers, desktop computers, and additional computing device form factors. The advertiser devices 118 may communicate the advertisement system 102 via the network 106.

Advertisers may use the advertiser devices 118 to generate advertisement data. For example, the advertiser devices 118 may run an application that displays a GUI to the advertiser which allows the advertiser to enter advertisement data. In some examples, the advertiser devices 118 may run an application that is dedicated to interfacing with the advertisement system 102, such as an application dedicated to generating advertisement data for advertisement records. In some examples, an advertiser device 118 may communicate with the advertisement system 102 using a more general application, such as a web-browser application, in order to generate advertisement data for advertisement records. The advertiser devices 118 transmit the advertisement data to the advertisement system 102. The advertisement system 102 may generate and/or update advertisement records in the advertisement data store 112 based on the advertisement data received from the advertiser devices 118.

As described above, the user devices 104, the advertiser devices 118, the search system 100, the advertisement system 102, and the data sources 120 may be in communication with one another via the network 106. The network 106 may include various types of networks, such as a wide area network (WAN) and/or the Internet. Although the network 106 may represent a long range network (e.g., Internet or WAN), in some implementations, the network 106 may include a shorter range network, such as a local area network (LAN). In one embodiment, the network 106 uses standard communications technologies and/or protocols. Thus, the network 106 can include links using technologies such as Ethernet, Wireless Fidelity (WiFi) (e.g., 802.11), worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 106 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 106 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In other examples, the network 106 can use custom and/or dedicated data communications technologies instead of, or in addition to, the ones described above.

FIG. 2 illustrates an example application search module 110 which may be included in the search system 100. The application search module 110 includes a query analysis module 122, an application set generation module 124 (hereinafter “set generation module 124”), and an application set processing module 126 (hereinafter “set processing module 126”). The query analysis module 122 analyzes a received search query 128. The set generation module 124 identifies a set of applications (e.g., application records) based on the received search query 128. The identified set of applications may be referred to herein as a “consideration set.” The set processing module 126 processes (e.g., scores) the consideration set to generate a set of search results 129 that may include a list of applications along with corresponding result scores indicating the relative rank of each application in a list.

As described above, the application data store 108 includes data related to a plurality of different applications. The data associated with an application may be referred to herein as an “application record” (e.g., application record 130 of FIG. 3A). Accordingly, the application data store 108 may include a plurality of different application records that each include data related to a different application.

Referring now to FIG. 3A, an example application record 130 includes an application name 132, an application identifier 134, and application attributes 136. The application record 130 may generally represent data stored in the application data store 108 that is related to an application. The application data store 108 may include a plurality of application records having a similar structure as the application record 130. Put another way, the application data store 108 may include a plurality of application records having an application name 132, an application identifier 134, and application attributes 136.

The application name 132 may be the name of the application represented by the data in the application record 130. Example application names may include “GOOGLE MAPS” by Google Inc., “FACEBOOK®” by Facebook, Inc., “TWITTER®” by Twitter Inc., or “ANGRY BIRDS®” by Rovio Entertainment Limited. The application identifier 134 (hereinafter “application ID 134”) identifies the application record 130 among the other application records included in the application data store 108. For example, the application ID 134 may uniquely identify the application record 130. The application ID 134 may be a string of alphabetic, numeric, and/or symbolic characters (e.g., punctuation marks) that uniquely identify the application record 130 in which the application ID 134 is included.

The application attributes 136 may include any type of data which may be associated with the application represented by the application record 130. The application attributes 136 may include a variety of different types of data. For example, the application attributes 136 may include structured, semi-structured, and/or unstructured data. The application attributes 136 may include information that is extracted or inferred from documents retrieved from the data sources 120. In some examples, the application attributes 136 may include data that is manually generated. The application attributes 136 may be updated so that up to date results can be provided in response to a user search query.

The application attributes 136 may include the name of the developer of the application, the publisher of the application, a category (e.g., genre) of the application, a description of the application (e.g., a developer's description), a version of the application, the operating system for the application, and the price of the application. The application attributes 136 may also indicate security or privacy data about the application, battery usage of the application, and bandwidth usage of the application.

Additionally, the application attributes 136 may include information that describes or otherwise indicates one or more of the following: one or more functions associated with the application, one or more internal states of the application, data used or provided by the application, data from online sources related to the application, the release date and/or the age of the application, and trustworthiness of the application.

The application attributes 136 may also include application statistics. Application statistics may refer to numerical data related to the application. For example, application statistics may include, but are not limited to, a number of downloads, a download rate (e.g., downloads per month), a number of ratings, and a number of reviews. The application attributes 136 may also include information retrieved from websites such as reviews associated with the application, articles associated with the application (e.g., wiki articles), or other information. The application attributes 136 may also include digital media related to the application, such as images (e.g., icons and/or sereenshots).

FIG. 3B illustrates an example application record 140 for the application (e.g., game) named “ANGRY BIRDS®” by Rovio Entertainment Limited. The application record 140 includes the application name “ANGRY BIRDS” indicated at 142. The application record 140 includes an application ID number indicated at 144. The application record 140 includes application attributes 146. The application attributes 146 include data fields for the name of the developer and the genre of the application. The developer of the application included in the application attributes 146 may be “Rovio Entertainment Limited.” The genre of the application may be “games.” The application attributes 146 also include fields for description and reviews. The description may include text that describes the ANGRY BIRDS® application. In some examples, the description may be provided by the developer of the application. The field for reviews may include text from user reviews in some examples.

The application attributes 146 also include fields for application statistics, such as ratings and the number of downloads. The ratings field may indicate the ratings given to the application by the users. For example, the ratings may include a number of stars (e.g., 0-5 stars) assigned to the application by the users. The number of downloads may indicate the total number of times the application has been downloaded.

Referring back to FIG. 2, the application search module 110 utilizes the search query 128 to perform an application search of the application data store 108. The query analysis module 122 receives the search query 128. The query analysis module 122 may perform various analysis operations on the received search query 128. For example, analysis operations performed by the query analysis module 122 may include, but are not limited to, tokenization of the search query 128, filtering of the search query 128, stemming, synonymization, and stop word removal.

The search query 128 may be a query entered by a user on a user device 104. The search query 128 may include text, numbers, and/or symbols (e.g., punctuation) entered into the user device 104 by the user. For example, the user may have entered the search query 128 into a search field (e.g., a search box) of an application running on the user device 104 using a touchscreen keypad, a mechanical keypad, and/or via speech recognition. In some examples, a user device 104 may transmit additional data along with the search query 128. The search query 128 and the additional data may be referred to as a query wrapper. The query wrapper a include information associated with the search query 128, such as platform constraint information (e.g., device type, operating system version, and web-browser version), geo-location information, partner specific information, and other information. The search system 100 and the advertisement system 102 may receive the query wrapper in some examples. The search system 100 and the advertisement system 102 may use the additional information included in the query wrapper to generate search results and advertisements.

The set generation module 124 identifies a set of applications i.e., the consideration set) based on the search query 128. In some examples, the set generation module 124 may identify the set of applications by identifying application records based on matches between terms of the search query 128 and terms in the application records. For example, the set generation module 124 may identify a set of applications in the application data store 108 based on matches between tokens generated by the query analysis module 122 and words included in the application records. The consideration set of applications may be a list of application records in some examples. For example, the consideration set may be a list of application IDs and/or a list of application names.

The set processing module 126 performs a variety of different processing operations on the consideration set to generate a set of search results 129 that includes a list of applications. In some implementations, the set processing module 126 may generate a result score for each of the applications included in the consideration set in order to generate the set of search results 129. In these implementations, the set of search results 129 may include a list of applications (e.g., application IDs and/or application names), each of which is associated with a corresponding result score. In some examples, the search results 129 may include all of the applications from the consideration set. In other examples, the search results 129 may include a subset of the consideration set. For example, the subset may be those applications having the largest result scores.

The information conveyed by the search results 129 may depend on how the result scores are calculated by the set processing module 126. For example, the result scores may indicate the relevance of an application to the search query, the popularity of an application, the quality of an application, or other properties of the application, depending on what parameters the set processing module 126 uses to score the applications.

The set processing module 126 may generate result scores for applications in a variety of different ways. In general, the set processing module 126 may generate a result score for an application based on one or more scoring features. The scoring features may be associated with the application and/or the search query 128. An application scoring feature may include any data associated with an application. For example, application scoring features may include any of the application attributes included in the application record or any additional parameters related to the application, such as data indicating the popularity of an application (e.g., number of downloads) and the ratings (e.g., number of stars) associated with an application. A query scoring feature may include any data associated with the search query 128. For example, query scoring features may include, but are not limited to, a number of words in the search query 128, the popularity of the search query 128, and the expected frequency of the words in the search query 128. An application-query scoring feature may include any data which may be generated based on data associated with both the application and the search query 128 that resulted in identification of the application record by the set generation module 124. For example, application-query scoring features may include, but are not limited to, parameters that indicate how well the terms of the search query 128 match the terms of the identified application record. The set processing module 126 may generate a result score for an application based on at least one of the application scoring features, the query scoring features, and the application-query scoring features.

The set processing module 126 may determine a result score based on one or more of the scoring features listed herein and/or additional scoring features not explicitly listed. In some examples, the set processing module 126 may include one or more machine learned models (e.g., a supervised learning model) configured to receive one or more scoring features. The one or more machine learned models may generate result scores based on at least one of the application scoring features, the query scoring features, and the application-query scoring features. For example, the set processing module 126 may pair the search query 128 with each application and calculate a vector of features for each (query, application) pair. The vector of features may include application scoring features, query scoring features, and application-query scoring features. The set processing module 126 may then input the vector of features into a machine-learned regression model to calculate a result score that may be used to rank the application in the search results 129 for the search query 128.

The results scores may be used in a variety of different ways. In some examples, the result scores may be used to rank the applications in a list of results that is presented on a user device 104. In these examples, a larger result score may indicate that the application is more relevant to a user than an application having a smaller result score. In examples where the search results 129 are displayed as a list on a user device 104, the applications associated with larger result scores may be listed nearer to the top of the results list (e.g., near to the top of the screen). In these examples, applications having lower result scores may be located farther down the list (e.g. off screen) and may be accessed by a user scrolling down the screen of the user device 104.

The set of search results 129 may be transmitted to a user device 104 that generated the search query 128 upon which the search results 129 are based. The search results 129 may be formatted on a user device 104 as a list of applications matching the search query 128. The search results 129 may include any information corresponding to the various applications. For example, the search results 129 provided by the search system 100 to a user device 104 may be formatted as a list of applications, including, for example, a name of the application, an image associated with the application (e.g., an icon, a screenshot, and/or a video), a link to download the application, a description and rating of the application, and/or other information.

The set of search results 129 may also be transmitted to the advertisement system 102. The advertisement system 102 may use the search results 129 as a basis for generating an advertisement for the user. The generated advertisement may be transmitted (e.g., served) to the user device 104 to be displayed along with the search results 129.

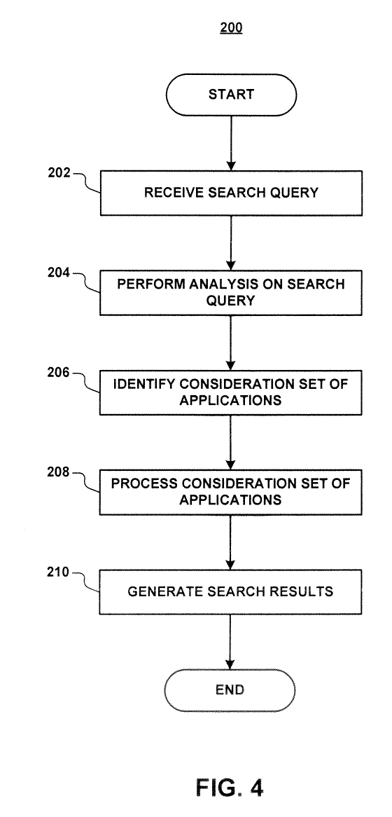

FIG. 4 illustrates an example method 200 for performing a search based on a received search query. The method 200 is described with reference to the application search module 110 of FIG. 2. In block 202, the query analysis module 122 receives a search query 128 generated by a user device 104. In block 204, the query analysis module 122 analyzes the search query 128.

In block 206, the set generation module 124 identifies a consideration set of applications (e.g. a set of application records) based on the search query 128 (e.g., based on output from the query analysis module 122). In block 208, the set processing module 126 processes the consideration set of applications. For example, the set processing module 126 may generate a result score for each of the applications in the consideration set. In block 210, the set processing module 126 generates a set of search results 129. The search results 129 may include a list of applications and associated result scores. The search system 100 may then transmit the search results 129 to a user device 104 and the advertisement system 102.

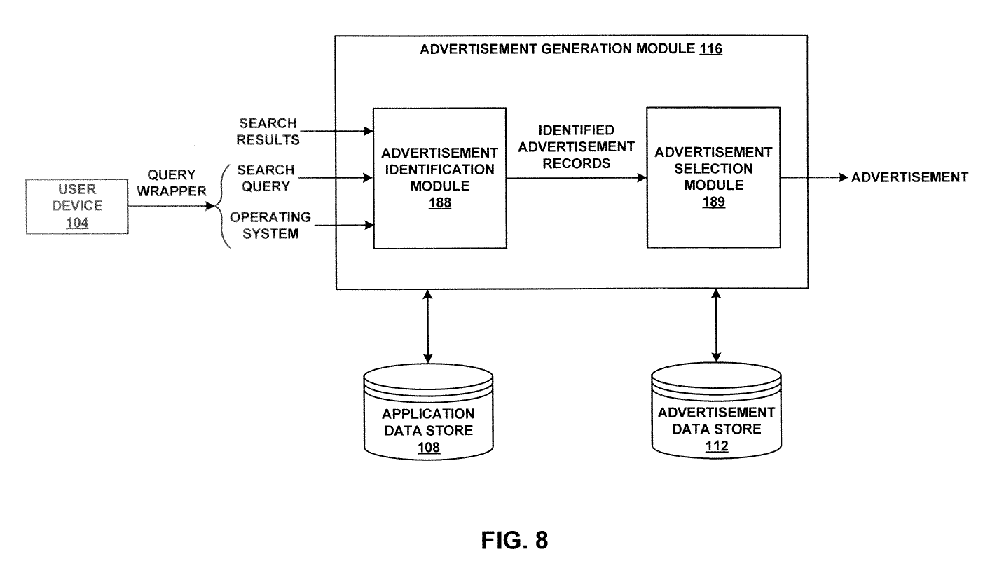

FIGS. 5-12 illustrate operation of the advertisement system 102. FIGS. 5-7 generally illustrate the generation of advertisement records and the generation of advertisements. FIGS. 8-12 illustrate operation of an example advertisement generation module 116 that may generate advertisements based on search results, data included in a query wrapper, data included in the advertisement data store 112, and data included in the application data store 108. FIGS. 5-12 are now described in turn.

FIG. 5 is a functional block diagram that illustrates example interactions between a user device 104, the search system 100, and the advertisement system 102. The functional block diagram of FIG. 5 also illustrates interactions between the advertiser devices 118 and the advertisement system 102. As described above, the user device 104 transmits a query wrapper including a search query to the application search module 110. The application search module 110 generates search results and transmits the search results to the user device 104.

The record generation module 114 receives advertisement data from the advertiser devices 118 and generates advertisement records based on the advertisement data received from the advertiser devices 118. The advertisement generation module 116 may receive the query wrapper, the search results, data from the advertisement data store 112 (e.g., advertisement records), and data from the application data store 108 (e.g., application records). The advertisement generation module 116 may generate advertisements based on data included in the query wrapper, the search results, the data included in advertisement data store 112, and the data included in the application data store 108.

The advertiser devices 118 may be used by advertisers to generate advertisement data. The advertiser devices 118 transmit advertisement data to the advertisement system 102. The record generation module 114 generates advertisement records based on the advertisement data received from the advertiser devices 118. The advertiser devices 118 may provide an interface (e.g., a GUI) that may be used by the advertiser to generate advertisement data to be included in advertisement records. The GUI may allow the advertiser to upload advertisement content and input advertisement parameters (e.g., targeting parameters) and other information included in an advertisement record. The GUI may include a set of text fields, check boxes, or other user interface elements for generating advertisement data to be included in an advertisement record.

FIGS. 6A-6B illustrate example advertisement records. An advertisement record may include a variety of different types of data related to an advertisement. The advertisement record 150 includes an advertisement record name/ID 152, a sponsored application name/ID 154, advertisement content 156, and advertisement parameters 158. The advertisement record 150 may represent data stored in the advertisement data store 112 that is related to an advertisement. The advertisement data store 112 may include advertisement records having a similar structure as the advertisement record 150. Put another way, the advertisement data store 112 may include a plurality of advertisement records indicating, for example, an advertisement record name/ID 152, a sponsored application name/ID 154, advertisement content 156, and advertisement parameters 158.

The advertisement record name/ID 152 identifies the advertisement record 150 among other advertisement records in the advertisement data store 112. For example, the advertisement record name/ID 152 may uniquely identify the advertisement record 150. The advertisement record name/ID 152 may be a string of alphabetic, numeric, and/or symbolic characters (e.g., punctuation marks) that uniquely identify the advertisement record 150 in which the advertisement record name/ID 152 is included. In some examples, the advertiser may generate the advertisement record name/ID 152. An advertiser may access and update generated advertisement records using the advertisement record name/ID 152.

The sponsored application name/ID 154 identifies the sponsored application associated with the advertisement record 150. As described herein, the advertisement content 156 and the advertisement parameters 158 of the advertisement record 150 may be directed to advertising the sponsored application identified by the sponsored application name/ID 154. The sponsored application name/ID 154 may include data that identifies the sponsored application, such as the name of the sponsored application and/or an application ID associated with the sponsored application.

Sponsored applications may be associated with an advertisement record in the advertisement data store 112 and an application record in the application data store 108. For example, an advertisement record in the advertisement data store 112 may include advertisement data related to a sponsored application. Additionally, an application record in the application data store 108 may include application data related to a sponsored application. Some of the applications described in the application data store 108 may not be associated with an advertisement record since every application in the application data store 108 may not be sponsored by an advertiser.

The sponsored application name/ID 154 of the advertisement record 150 may correspond to an application name and/or an application ID of an application record in the application data store 108. FIG. 3B and FIG. 6B illustrate how a sponsored application name/ID may correspond to an application name and/or an application ID included in an application record. Advertisement record 160 of FIG. 6B includes the sponsored application name “ANGRY BIRDS” having ID “ID#1.” Accordingly, the advertisement record 160 may be an advertisement record for the application named “ANGRY BIRDS®” by Rovio Entertainment Limited. The application data store 108 may include an application record including application data for the “ANGRY BIRDS®” application. For example, with respect to FIG. 3B, the application data store 108 may include application record 140 having an application name “ANGRY BIRDS” and an application ID “ID#1,” which corresponds to the sponsored application name/ID of the advertisement record 160. As described herein, the advertisement system 102 (e.g., the advertisement generation module 116) may determine whether to generate an advertisement for a sponsored application based on data from both an advertisement record and an application record associated with the sponsored application.

Referring back to FIG. 6A, the advertisement record 150 includes advertisement content 156. Advertisement content 156 may include data in the advertisement record 150 that is used by the advertisement system 102 (e.g., the advertisement generation module 116) to generate an advertisement for the sponsored application. For example, advertisement content 156 may include text associated with the sponsored application, such as a description of the sponsored application and the name of the developer of the sponsored application. In some examples, the advertisement content 156 may include text indicating to a user that the advertisement generated by the advertisement system 102 is an advertisement for the sponsored application, instead of a search result generated in response to a search query. For example, the advertisement content 156 may include text, such as “Sponsored Application,” “Sponsored Result.” or “Advertise ent,” which may be displayed on a user device 104 along with other information in the advertisement. In some examples, the advertisement content 156 may include a message prompting a user to download the application (e.g., “Download Now!”).

The advertisement content 156 may include images, animations, and videos associated with the sponsored application. An image may include an application icon which may be displayed on a mobile device. An application icon may be an image that represents the application. An image may also include screenshots of the sponsored application. Animations may include a series of images, such as screenshots or other images associated with the sponsored application. Videos may include, but are not limited to, demonstrations of the sponsored application and gameplay footage of the sponsored application. Generally, the advertisement content 156 described above may include any manually-input content and/or any auto-populated content. Additionally, the advertisement content 156 may specify any of one or more formats for a corresponding advertisement, such as, for example, still image, video, animation, and other formats. Moreover, advertisement content 156 may specify different formats for advertisements that are new or are being generated on atrial (e.g., “test drive”) basis, relative to existing advertisements.

The advertisement content 156 may also include links to locations from which the sponsored application may be downloaded. For example, the advertisement content 156 may include hyperlinks to one or more digital distribution platforms from which the sponsored application may be downloaded. The advertisement transmitted (e.g., served) to a user device 104 may include one or more links that the user may select in order download the sponsored application to the user device 104.

FIG. 7 illustrates an example GUI on a user device 162 that includes search results 163 and an advertisement 164. The advertisement 164 may include advertisement content from an advertisement record. The user device 162 may be a smart phone. The user device 162 includes a housing 165, a speaker 166, and mechanical buttons 167. The display of the user device 162 displays a GUI that includes a search field 168 that receives a search query from a user. In FIG. 7, the search query “Toy Story” was entered by a user and transmitted to the search system 100.

The GUI displays search results 163 generated by the search system 100. The search results 163 are listed below the search field 168. The search results 163 are labeled as “Search Results.” The search results include application icons (e.g., icon 169), application names, application descriptions, application ratings, and download buttons (e.g., button 170) for downloading the applications. The example applications in the search results include “FLIXSTER®” by Flixster Inc. “TOY STORY® 3” by Disney Enterprises Inc., “YOUTUBE®” by Google Inc.,” and “IMDB®” by IMDb.com Inc. In some examples, the user may scroll down the screen to view additional search results generated by the search system 100.

The GUI displays an example advertisement 164 that may be generated by the advertisement system 102. The example advertisement 164 is for the sponsored application named “FANDANGO®” by Fandango LLC. The advertisement for “FANDANGO®” is labeled as an “Advertisement.” The advertisement 164 includes an application icon 171 that represents the sponsored application. The advertisement 164 also includes a description 172, ratings 173, and a download button 174. The user may interact with the download button 174 (e.g., press the download button 174) in order to download the sponsored application or be directed to a digital distribution platform that provides the sponsored application for download.

Referring back to FIG. 6A, the advertisement record 150 includes advertisement parameters 158. Advertisement parameters 158 may include a variety of different targeting parameters including, but not limited to, similarity targeting parameters, keyword targeting parameters, and platform targeting parameters. The advertisement record 150 may also include a targeting parameter function that defines which of the targeting parameters should be satisfied in order for the advertisement generation module 116 to generate an advertisement based on the advertisement content 156 of the advertisement record 150. Put another way, the advertisement generation module 116 may determine whether to generate an advertisement for a sponsored application of the advertisement record 150 based on whether one or more of the targeting parameters of the advertisement record 150 (e.g., of the advertisement parameters 158) are satisfied. In general, the advertisement generation module 116 may generate an advertisement for a sponsored application of an advertisement record when one or more targeting parameters of the advertisement record are satisfied.

Example targeting parameters, such as similarity targeting parameters, keyword targeting parameters, and platform targeting parameters are now described in turn. A similarity targeting parameter may be a condition that is satisfied when two applications are similar. For example, a similarity targeting parameter of an advertisement record may be satisfied when the sponsored application of the advertisement record is determined to be similar to one or more of the applications in the search results. In a more specific example, a similarity targeting parameter may indicate that the sponsored application should be advertised when the sponsored application is similar to the highest ranked application in the search results. In another example, a similarity targeting parameter may indicate that the sponsored application should be advertised when the sponsored application is similar to at least two of the applications in the search results. As described herein, the advertisement generation module 116 may determine whether two applications are similar.

A keyword targeting parameter may be a condition that is satisfied when one or more keywords are included in the search query. The one or more keywords may be included in the advertisement record. The one or more keywords may be words specified by an advertiser (e.g., using an advertiser device 118). For example, the advertiser may indicate that the sponsored application of the advertisement record should be advertised when the advertisement generation module 116 identities one or more of the keywords in the search query.

A platform targeting parameter may be a condition that is satisfied when the operating system of the user device 104 that generated the search query matches an operating system listed in the advertisement record. The advertisement generation module 116 may determine the operating system of the user device 104 based on information included in the query wrapper transmitted to the advertisement system 102 by the user device 104. Platform targeting parameters may also include conditions related to the type of user device that generated the search query and/or the web-browser running on the user device.

Although similarity targeting parameters, keyword targeting parameters, and platform parameters are described above, targeting parameters may include additional parameters, such as geographic targeting parameters. A geographic targeting parameter may be a condition that is satisfied based on the location of the user device that generated the search query, which may be indicated in the query wrapper. Additional targeting parameters (e.g. time-slotting, day-parting, category, geographical, contextual, demographic, behavioral, platform, device, and partner parameters can also be implemented.

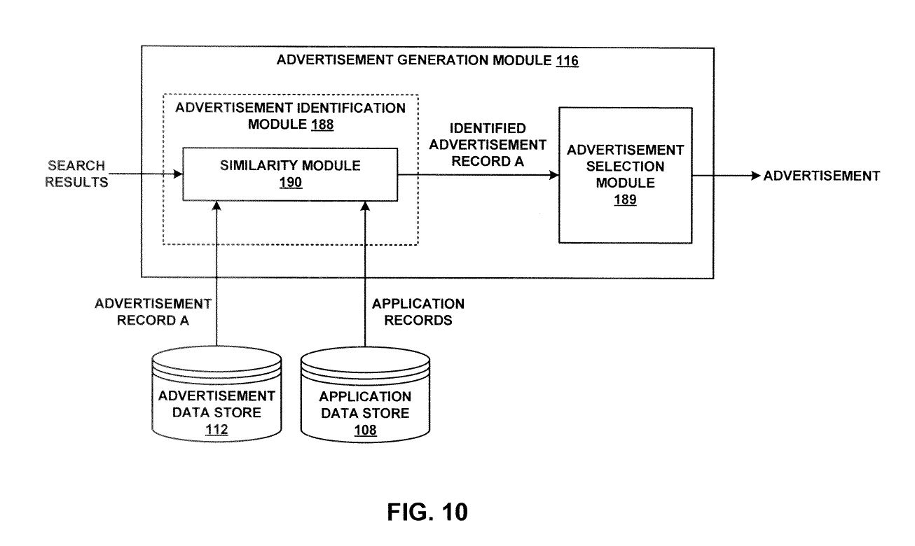

As described above, the advertisement parameters 158 may include a targeting parameter function that defines which of the targeting parameters of the advertisement record 150 should be satisfied in order for the advertisement system 102 to generate an advertisement. The targeting parameter function may include one or more targeting parameters. In some examples, a targeting parameter function may include a single targeting parameter. In these examples, the advertisement generation module 116 may generate an advertisement for a sponsored application of an advertisement record based on satisfaction of a single targeting parameter in the advertisement record. FIG. 10 illustrates an example scenario in which the advertisement generation module 116 may generate an advertisement based on satisfaction of a single targeting parameter (e.g., a similarity targeting parameter).

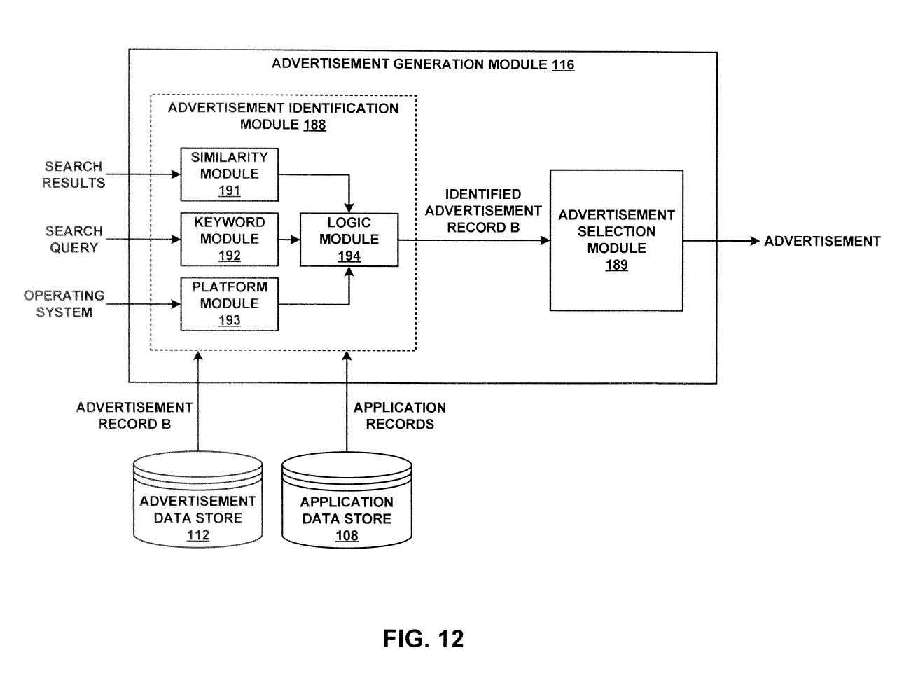

In other examples, a targeting parameter function may include multiple different targeting parameters. In these examples, the advertisement generation module 116 may generate an advertisement for a sponsored application of an advertisement record when the multiple targeting parameters of the advertisement record are satisfied. The one or more targeting parameters may include one or more similarity targeting parameters, one or more keyword targeting parameters, and one or more platform targeting parameters. In these examples, the targeting parameter function may include a Boolean function. FIG. 12 illustrates an example scenario in which the advertisement generation module 116 may generate an advertisement based on satisfaction of multiple targeting parameters.

The advertisement record 150 may include additional advertisement parameters 158 that may be defined by the advertiser. Additional advertisement parameters 158 may include timing parameters, budget parameters, and user parameters. Timing parameters may define the date(s) and/or time(s) of day at which advertising for a sponsored application should start and/or stop. Budget parameters may indicate a total advertising budget, an advertisement bid price, or other budget parameters associated with a sponsored application. User parameters may specify which of one or more languages associated with the user's search query will cause the advertisement generation module 116 to generate an advertisement for a sponsored application. User parameters may also define whether the advertisement generation module 116 will generate and provide the same advertisement to a particular user more than once. Additional advertisement parameters (e.g., time-slotting, day-parting, category, geographical, contextual, demographic, behavioral, platform, device, and partner parameters) have also been previously described.

FIG. 6B illustrates an example advertisement record 160 that includes example advertisement data for the application described in the application record 140 of FIG. 3B. The advertisement record 160 includes an advertisement record name/ID 180. The advertisement record name is “ADVERTISEMENT FOR ANGRY BIRDS.” The advertisement record ID is “ID#9.” The advertisement record name/ID 180 may be used to identify the advertisement record 160 among other advertisement records in the advertisement data store 112. The advertisement record name/ID 180 may be generated by the advertiser in some examples. For example, the advertiser may enter the advertisement record name into an advertiser device 118. The record generation module 114 may generate the advertisement record ID in some examples.

The sponsored application name for the advertisement record 160 is “ANGRY BIRDS.” The sponsored application ID for the advertisement record 160 is “ID#1.” Accordingly, as described above, the advertisement record 160 includes advertisement data for advertising the application described by the application record 140 of FIG. 3B. Similarly, the application record 140 of FIG. 3B includes application data for the sponsored application associated with the advertisement record 160.

The advertisement record 160, as part of its advertisement parameters, includes a targeting parameter function 181. The targeting parameter function 181 includes similarity targeting parameters 182, keyword targeting parameters 183, and platform targeting parameters 184. Accordingly, the advertisement generation module 116 may generate an advertisement including advertisement content 185 also included within the advertisement record 160 when the similarity targeting parameters 182, the keyword targeting parameters 183, and the platform targeting parameters 184 are satisfied. The advertisement record 160 also includes additional advertisement parameters 186 including timing parameters and budget parameters. In some examples, the additional advertisement parameters 186 may also include user parameters, which have been previously described.

The application data store 108 and the advertisement data store 112 represent features that may be included in the search system 100 and the advertisement system 102, respectively. The application data store 108 and the advertisement data store 112 are illustrated as separate for descriptive purposes. Illustration of the application data store 108 and the advertisement data store 112 as separate does not necessarily imply whether the data stores are embodied by common or separate electronic hardware or software components. Similarly, the application records and advertisement records may represent data that may be included in the application data store 108 and/or the advertisement data store 112. Illustration of the application records and advertisement records as separate does not necessarily imply whether the data associated with the records is stored in common or separate hardware components.

Referring back to FIG. 6A, the advertiser devices 118 may be used by advertisers to generate any of the above data that may be included in the advertisement record 150. For example, the advertiser devices 118 may be used by advertisers to generate the advertisement record name/ID 152, the sponsored application name/ID 154, the advertisement content 156, and the advertisement parameters 158. The record generation module 114 may provide the interface (e.g., a GUI) to the advertiser devices 118 that may be used by the advertisers to generate the advertisement data. The GUI may include interface elements that allow the advertiser to upload advertisement content, input advertisement parameters (e.g., targeting parameters and targeting parameter functions), and input other information included in the advertisement record.

The GUI may include interface elements (e.g., text boxes) for specifying the advertisement record name and the sponsored application name/ID. The GUI may also include interface elements for entering similarity parameters. For example, the GUI may include a checkbox that the advertiser may check to indicate that the targeting parameter function should include similarity targeting parameters. The GUI may also include interface elements (e.g., a checkbox or text box) for entering a function including similarity parameters. For example, the advertiser may use the GUI to indicate that an advertisement should be generated when the sponsored application is similar to any of the applications in the search results. As an additional example, the advertiser may use the GUI to indicate that an advertisement should be generated when the sponsored application is similar to the highest ranked application in the search results.

The GUI may also include other interface elements for specifying other targeting parameters, such as keyword targeting parameters. For example, the GUI may include text fields (e.g., text boxes) for entering keywords that define keyword targeting parameters. The GUI may also include an interface element, such as a button, that the advertiser uses to submit the data entered into the GUI to the record generation module 114. The record generation module 114 may generate an advertisement record in the advertisement data store 112 based on the data received from the advertiser device 118.

FIG. 8 is a functional block diagram of an example advertisement generation module 116 that includes an advertisement identification module 188 (hereinafter “identification module 188”) and an advertisement selection module 189. The identification module 188 may identify one or more advertisement records in the advertisement data store 112 based on the search results, data included in the query wrapper, and data included in the application data store 108. For example, the identification module 188 may identify one or more advertisement records having targeting parameters that are satisfied based on the search results, data included in the query wrapper, and data included in the application data store 108. The advertisement selection module 189 selects one or more of the identified advertisement records and generates one or more advertisements based on the selected advertisement records. For example, the advertisement selection module 189 may select one or more of the identified advertisement records in response to a single search, because the targeting parameter functions for those advertisement records are satisfied. The advertisement selection module 189 may select which advertisements to generate from a list of different possible advertisements based on budget parameters (e.g., advertising the app with the highest bid price) and/or popularity (e.g., as specified by a corresponding advertisement record). In some examples, the advertisement selection module 189 may select which advertisements to generate based on any combination of bid price, relevance to the search query, release date and/or age of an advertisement, remaining impressions to fulfill (e.g., how many times a particular advertisement is to be generated), as well as any number of other considerations.

The advertisement generation module 116 (e.g., the identification module 188 and the advertisement selection module 189) may be configured to generate an advertisement for each set of search results generated by the search system 100. The identification module 188 may identify one or more advertisement records in response to receiving the query wrapper and the search results. For example, the identification module 188 may identify one or more advertisement records that have targeting parameters (e.g., the targeting parameter function) that are satisfied by the search results and/or data included in the query wrapper. In some examples, the identification module 188 may identify a single advertisement record having targeting parameters that are satisfied. In other examples, the identification module 188 may identify multiple advertisement records having targeting parameters that are satisfied.

The identification module 188 may check multiple advertisement records in the advertisement data store 112 to determine whether any of the multiple advertisement records have targeting parameters that are satisfied. In some examples, the identification module 188 may check most, or all, of the advertisement records in the advertisement data store 112 to determine whether any of the advertisement records have targeting parameters that are satisfied. For example, the identification module 188 may initially determine whether the targeting parameters (e.g., the targeting parameter (unction) of a first advertisement record are satisfied. If the targeting parameters of the first advertisement record are satisfied, the identification module 188 may identify the advertisement record as being a candidate for advertisement. After determining whether the targeting parameters of the first advertisement record are satisfied, the identification module 188 may determine whether the targeting parameters of a second advertisement record are satisfied. The identification module 188 may continue to determine whether the targeting parameters of additional advertisement records (e.g., most or all) are satisfied.

The advertisement selection module 189 selects one of the identified advertisement records identified by the identification module 188. The advertisement selection module 189 may generate an advertisement based on the selected advertisement record. For example, the advertisement selection module 189 may generate an advertisement that includes advertisement content from the selected advertisement record. In some examples, the advertisement selection module 189 may generate an advertisement based on data included in the application data store 108. For example, the advertisement selection module 189 may retrieve text and images from the application record for the sponsored application in order to generate an advertisement for the sponsored application.

The advertisement selection module 189 may transmit (e.g., serve) the generated advertisement to the user device that generated the search query. Accordingly, the user device that generated the search query may receive the generated advertisement along with search results including a list of applications. The user device may display the advertisement along with the search results, as illustrated in FIG. 7. Although the advertisement selection module 189 may generate a single advertisement in some implementations, in other implementations, the advertisement selection module 189 may select multiple identified advertisement records and generate multiple advertisements based on the multiple identified advertisement records.

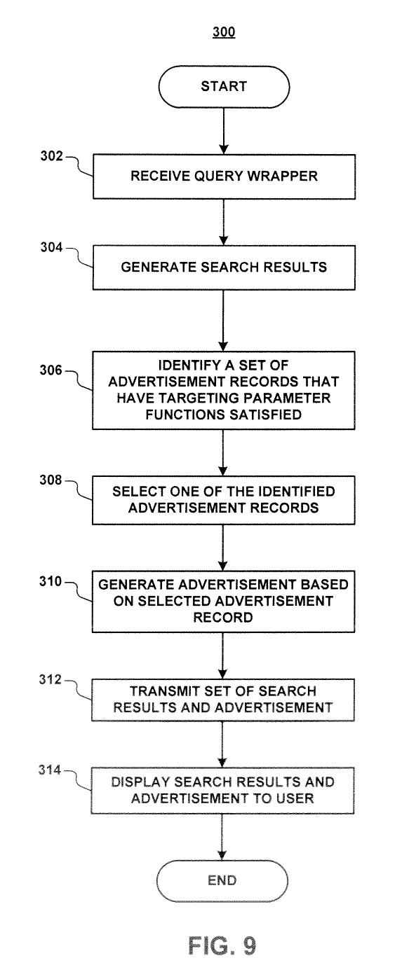

FIG. 9 illustrates a method 300 for generating search results and an advertisement for the search results. The method 300 is described with reference to the application search module 110 of FIG. 2 and the advertisement generation module 116 of FIG. 8. In block 302, the application search module 110 and the identification module 188 receive a query wrapper including a search query. In block 304, the application search module 110 generates search results based on the received search query.

In block 306, the identification module 188 identifies a set advertisement records (e.g., one or more advertisement records) that include targeting parameter functions that are satisfied. In block 308, the advertisement selection module 189 selects one of the identified advertisement records. In block 310, the advertisement selection module 189 generates an advertisement based on the advertisement content of the selected advertisement record.

In block 312, the application search module 110 transmits the search results to the user device that generated the search query. Additionally, the advertisement selection module 189 transmits (e.g., serves) the advertisement to the user device that generated the search query. In block 314, the user device that generated the search query displays the search results and the advertisement to the user.

FIG. 10 is a functional block diagram illustrating operation of the advertisement generation module 116. In the example of FIG. 10, the identification module 188 chooses advertisement record A from the advertisement data store 112. Accordingly, the identification module 188 determines whether the targeting parameter function of advertisement A is satisfied. FIG. 12 illustrates operation of the identification module 188 in another example where the identification module 188 chooses advertisement record B that includes a different targeting parameter function. As described hereinafter, the identification module 188 may implement different modules according to the targeting parameter function included in the chosen advertisement record.

It may be assumed that advertisement record A includes a targeting parameter function that includes similarity targeting parameters. Accordingly, identification module 188 may implement a similarity module 190 that determines whether the similarity targeting parameters of advertisement record A are satisfied. Furthermore, it may be assumed that the targeting parameter function of advertisement record A indicates that the sponsored application of advertisement record A should be advertised when any of the applications of the search results is similar to the sponsored application. Accordingly, the similarity module 190 is configured to determine whether any one of the applications indicated by the search results is similar to the sponsored application listed in advertisement record A.

The similarity module 190 may determine whether two applications are similar. In some implementations, the similarity module 190 may determine a similarity score of two applications. A similarity score is a numerical value that indicates the degree of similarity between two different applications. In some implementations, the similarity score is a value from 0.0 to 1.0. In some implementations, the similarity module 190 may determine that two applications are similar when the similarity score for the two applications is greater than a threshold similarity score. In these implementations, the similarity module 190 may determine that the two applications are dissimilar (i.e., not similar to one another) when the similarity score is less than the threshold similarity score.

The similarity module 190 may determine the similarity score in a variety of manners. In some implementations, the similarity module 190 may determine a similarity score for two applications based on text matches between the application records of the two applications. In other implementations, the similarity module 190 may determine a similarity score for two applications based on whether the two applications are included in the same category (e.g., genre). In still other implementations, the similarity module 190 may determine a similarity score for two applications based on click data, or similarity data, associated with the two applications, in the manner already described above. In some implementations, the similarity module 190 may determine a similarity score for two applications based on any combination of text matches between the corresponding application records, the categories of the applications (e.g., as specified by the application records), click data associated with the applications, and other types of data associated with the applications and/or their application records.

The similarity module 190 may compare a sponsored application to applications included in the search results. For example, the similarity module 190 may select which applications in the search results to compare to a sponsored application based on the similarity targeting parameters included in the chosen advertisement record. In an example where the similarity targeting parameters of an advertisement record indicate that the sponsored application should be advertised when it is similar to any of the applications of the search results, the similarity module 190 may compare each of the applications in the search results to the sponsored application from the advertisement record. In an example where the similarity targeting parameters indicate that the sponsored application should be advertised when it is similar to the highest ranked application in the search results, the similarity module 190 may compare the highest ranked application in the search result to the sponsored application from the advertisement record.

The similarity module 190 may determine whether two applications are similar based on data included in the application records of the two applications. For example, the similarity module 190 may determine a similarity score based on data included in the application records of the two applications. In some implementations, the similarity module 190 may determine a similarity score for two applications based on matches between the categories of the applications. For example, the similarity module 190 may generate a larger similarity score (e.g., closer to 1.0) when two applications are included in the same categories.

In some implementations, the similarity module 190 may determine a similarity score for two applications based on text matches between the application records of the two applications. For example, the similarity module 190 may detect text matches between application attributes including, but not limited to, the developer of the application, the publisher of the application, a description of the application (e.g., a developer's description), information retrieved from websites (e.g., reviews) associated with the application, articles associated with the application (e.g., wiki articles), or other information. In some examples, a greater number of text matches may tend to yield a larger similarity score (e.g., closer to 1.0).

In some implementations, the similarity module 190 may determine a similarity score for two applications based on matches between other types of data included in the application records of the two applications. For example, the similarity module 190 may determine the similarity score based on data including, but not limited to, the operating systems of the applications, the prices of the applications, security or privacy data about the applications, battery usage of the applications, bandwidth usage of the applications, and application statistics associated with the applications. The similarity module 190 may also determine the similarity score based on functions associated with the applications, internal states of the applications, data used or provided by the applications, online source data related to the applications, release dates and/or ages of the applications, and trustworthiness of the applications.

Additionally, as explained above, in other implementations, the similarity module 190 may determine the similarity score based on click data, or similarity data, for the two applications. As one example, a user selecting each of the two applications in a particular setting (e.g., from search results responsive to an application search query, or from a list of applications grouped based on category) may result in a larger similarity score (e.g., 1.0) for the applications. In contrast, a user not selecting each of the two applications in the same or similar setting may result in a smaller similarity score (e.g. 0.0) for the applications. As another example, a greater number of times that a user has selected the two applications in such a setting may result in a relatively larger similarity score (e.g., closer to 1.0) for the applications.

In some examples, the similarity module 190 may determine a similarity score for two applications based on a similarity matrix that includes a similarity score for each of one or more pairs of applications. In these examples, the one or more pairs of applications may correspond to pairwise groupings of some or all applications included in the application data store 108. Thus, if the application data store 108 includes N applications, the similarity matrix may be an N×N matrix that includes N*N, or N² similarity scores, with one similarity score associated with each pairwise grouping of the N applications. As previously explained, the similarity score for the two applications of each pair of applications indicates a degree of similarity between the two applications. For a pairwise grouping of a particular application within the application data store 108 with itself, the similarity score included in the similarity matrix may be 1.0, indicating that the two applications of the corresponding pair of applications are the same. Alternatively, in other examples, similarity scores for pairwise groupings of the same application may be omitted from the similarity matrix.

In the examples described above, each similarity score included in the similarity matrix represents a quantitative measure of how similar a given application is to another application. The similarity scores can be calculated in any suitable manner. In some implementations, each similarity score for two applications is calculated based on one or more of 1) a latent semantic indexing (LSI) cosine-similarity value for the applications, 2) a text similarity value (e.g., based on text matches between the corresponding application records) for the applications, and 3) an importance value (e.g., based on numbers of downloads and/or average rating values) for the applications, as well as based on any number of additional or alternative attributes of the applications. Additionally, heuristic and natural language processing techniques may be applied to determine the attributes that are used to determine the similarity scores for the applications. In some examples, the similarity matrix described above can be calculated offline and can be updated in any suitable manner.

To determine a similarity score for a first application and a second application (i.e., to determine whether, and to what degree, the two applications are similar) using the similarity matrix, the similarity module 190 may identify a location (e.g., a row and a column) in the similarity matrix that corresponds to the pairwise grouping of the two applications and extract the similarity score included therein. The similarity module 190 can repeat this process for pairwise groupings of the first application with other applications to determine the corresponding similarity scores. For each extracted similarity score, the similarity module 190 may compare the similarity score to a corresponding threshold similarity score to determine whether the two applications associated with the similarity score are similar. In this manner, the similarity module 190 may compare the sponsored application from the advertisement record to one or more applications (e.g., each application, or the highest ranked application) in the search results, as described above.

With respect to FIG. 10, the similarity module 19U may determine whether the sponsored application of advertisement record A is similar to any of the applications in the search results. For example, the similarity module 190 may determine similarity scores between the sponsored application of advertisement record A and each application in the search results. The similarity module 190 may determine that two applications are similar when the similarity score associated with the two applications is greater than a threshold similarity score.

As described above, advertisement record A may include a targeting parameter function that is satisfied when the sponsored application is similar to one or more of the applications in the search results. In FIG. 10, the similarity module 190 determines that the sponsored application of advertisement record A is similar to one or more of the applications in the search results. Accordingly, the targeting parameter function of advertisement A is satisfied. Therefore, the similarity module 190 identifies advertisement record A as a candidate for advertisement.

As described above, the identification module 188 may choose additional advertisement records after advertisement record A. The identification module 188 may determine whether the targeting parameter functions of the additional advertisement records are satisfied. In some examples, the identification module 188 may identify additional advertisement records having targeting parameter functions that are satisfied. The advertisement selection module 189 may then select one or more of the identified advertisement records. The advertisement selection module 189 generates an advertisement based on the one or more selected advertisement records.

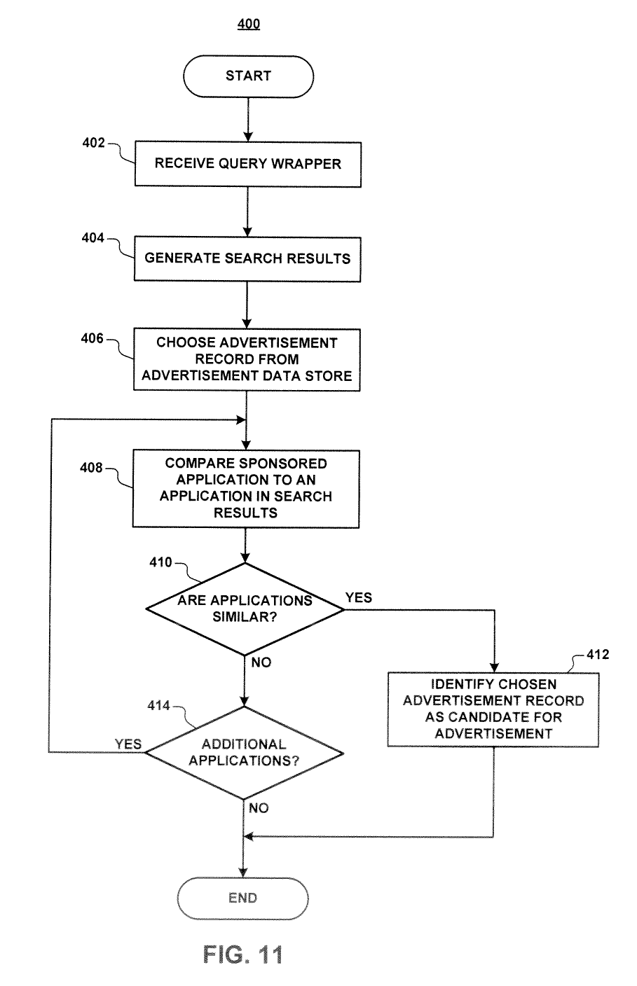

FIG. 11 illustrates a method 400 for generating an advertisement for a sponsored application based on whether applications included in the search results are similar to the sponsored application. The method 400 is described with reference to the application search module 110 of FIG. 2 and the advertisement generation module 116 of FIG. 10. In block 402, the application search module 110 and the identification module 188 receive a query wrapper including a search query. In block 404, the application search module 110 generates search results based on the received search query.

In block 406, the identification module 188 chooses an advertisement record from the advertisement data store 112. For example, the identification module 188 may chose the advertisement record A, described above. To perform the portions of the method 400 specified by blocks 408-414, the identification module 188 implements the similarity module 190 described above. In block 408, the similarity module 190 compares a first one of the applications in the search results to the sponsored application of advertisement record A. The similarity module 190 may determine a similarity score based on the amount of similarity between the first one of the applications in the search results and the sponsored application of advertisement record A. In block 410, the similarity module 190 determines whether the first one of the applications in the search results is similar to the sponsored application of advertisement record A.

If the first one of the applications in the search results is similar to the sponsored application of advertisement record A, the method 400 may continue in block 412. In block 412, the similarity module 190 may identify advertisement record A as a candidate for advertisement. If the first one of the applications in the search results is not similar to the sponsored application of advertisement record A, the method continues in block 414. In block 414, the similarity module 190 determines whether the sponsored application may be compared to additional applications in the search results. Additional comparisons may be made if the sponsored application has not yet been compared to each of the applications in the search results. If additional comparisons can be made, the similarity module 190 may compare a different application in the search results to the sponsored application in block 408. For example, the similarity module 190 may compare a second one of the applications in the search results to the sponsored application in block 408. In this manner, the similarity module 190 may determine whether any of the applications listed in the search results is similar to the sponsored application of the chosen advertisement record.

Referring now to FIG. 12, the identification module 188 has chosen advertisement record B from the advertisement data store 112. Advertisement record B includes a different targeting parameter function than advertisement record A. Accordingly, the identification module 188 may implement a different set of modules for determining whether the targeting parameter function of application record B is satisfied, as discussed below.

It may be assumed that advertisement record B includes a targeting parameter function that includes similarity targeting parameters, keyword targeting parameters, and platform targeting parameters. The identification module 188 implements a similarity module 191 that determines whether the similarity targeting parameters of advertisement record B are satisfied. For example, the similarity targeting parameters may be satisfied when any of the applications in the search results is similar to the sponsored application of advertisement record B. The identification module 188 implements a keyword module 192 that determines whether the keyword targeting parameters of advertisement record B are satisfied. For example, the keyword targeting parameters may be satisfied when words from the search query match key words included in advertisement record B. The identification module 188 implements a platform module 193 that determines whether platform targeting parameters of advertisement record B are satisfied. For example, the platform targeting parameters may be satisfied when the operating system of the user device that generated the search query matches the operating system listed in advertisement record B.

The identification module 188 includes a logic module 194 that may implement a logic function (i.e., a targeting parameter function) defined by an advertiser. The logic function may define which of the targeting parameters of advertisement record B should be satisfied in order to generate an advertisement. For example, the logic function included in advertisement record B may indicate that advertisement record B is a candidate for advertisement when all of the similarity targeting parameters, keyword targeting parameters, and platform targeting parameters are satisfied. Alternatively, the logic function included in advertisement record B could indicate that advertisement record B is a candidate for advertisement when two of the targeting parameters are satisfied.

As described above with respect to FIGS. 10-12, the advertiser may generate a custom advertisement record with a variety of different targeting parameters and targeting parameter functions. In some examples, the advertiser may generate an advertisement record that includes a single targeting parameter (e.g., a similarity targeting parameter). In other examples, the advertiser may generate an advertisement record that includes a targeting parameter function including multiple targeting parameters as part of a Boolean logic function.

Some example targeting parameter functions are described above with respect to FIG. 10 and FIG. 12. An advertiser may generate a variety of different targeting parameter functions including different numbers and types of targeting parameters and different logical operators including, but not limited to, an AND logical operator, an OR logical operator, an XOR logical operator, and a negation logical operator (e.g., inverter). For example, an advertiser may generate a similarity targeting parameter that indicates a sponsored application should be advertised when the sponsored application is not similar (i.e., dissimilar) to an application in the search results. In this example, the advertisement generation module 116 may determine that the targeting parameter function is satisfied when the sponsored application is not similar to the application in the search results. The advertisement generation module 116 may determine that the sponsored application and the application in the search results are dissimilar when the similarity score for the two applications is less than the threshold similarity score.

Although the advertisement system 102 is described herein as generating an advertisement for a user device in response to a search query, in some examples, the advertisement system 102 may refrain from generating an advertisement. For example, the advertisement system 102 may refrain from generating an advertisement when the identification module 188 does not identify an advertisement record that has a targeting parameter function that is satisfied. In these examples, the search system 100 may generate search results, but the advertisement system 102 may refrain from generating an advertisement to be displayed along with the search results.

In some examples, the advertisement system 102 may include a similarity lookup table that may increase the speed of determining a similarity score. The similarity lookup table may include similarity scores for different pairs of applications. For example, the similarity lookup table may include a similarity score for all possible pairs of applications in some examples. In general, the similarity lookup table may include any type of information that indicates similarity among two or more applications (i.e., without necessarily using similarity scores). In any case, the advertisement system 102 may update the similarity lookup table over time as applications are added and removed from digital distribution platforms. The advertisement system 102 may also update the similarity lookup table over time as modifications are made to applications, which may be reflected in the application records. At search time, the advertisement generation module 116 (e.g., the similarity modules 190, 191) may quickly determine whether two applications are similar or dissimilar by using the similarity lookup table. In some examples, the advertisement system 102 may include additional lookup tables for different targeting parameter functions including similarity targeting parameters and other targeting parameters.

Modules and data stores included in the search system 100 and the advertisement system 102 represent features that may be included in the search system 100 and the advertisement system 102 of the present disclosure. For example, the application search module 110, the record generation module 114, the advertisement generation module 116, the application data store 108, and the advertisement data store 112 may represent features included in the search system 100 and the advertisement system 102. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the application data (e.g., application records) included in the application data store 108 and the advertisement data (e.g., advertisement records) included in the advertisement data store 112. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the systems 100, 102 may be systems of one or more computing devices (e.g., a computer search system and a computer advertising system) that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices include any combination of processing units, memory components. I/O components, and interconnect components described above. The one or more computing devices of the systems 100, 102 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems 100, 102 may be configured to communicate with the network 106. The one or more computing devices of the systems 100, 102 may also be configured to communicate with one another via a computer network. In some examples, the one or more computing devices of the systems 100, 102 may include one or more server computing devices configured to communicate with user devices (e.g., receive search queries and transmit search results and advertisements), gather data from data sources 120, index data, store the data, and store other documents. The one or more computing devices may reside within a single machine at a single geographic location in some examples. In other examples, the one or more computing devices may reside within multiple machines at a single geographic location. In still other examples, the one or more computing devices of the systems 100, 102 may be distributed across a number of geographic locations.

What is claimed is:

1. A method comprising:
receiving a search query from a computing device;
performing a search for software applications using the search query;
generating a list of N software applications identified during the search, wherein N is an integer greater than or equal to 1;
identifying an advertisement record in an advertisement data store, wherein the advertisement data store includes one or more advertisement records, each advertisement record listing a sponsored application associated with the advertisement record and including advertisement content for the sponsored application, wherein identifying the advertisement record comprises determining that the sponsored application of the identified advertisement record is similar to at least one of the N software applications identified during the search;
generating an advertisement for the sponsored application based on the advertisement content in the identified advertisement record; and
transmitting the list of the N software applications and the generated advertisement to the computing device.

2. The method of claim 1, wherein determining that the sponsored application is similar to at least one of the N software applications comprises:
selecting one of the N software applications;
determining a similarity score that indicates an amount of similarity between the sponsored application and the selected software application; and
determining that the sponsored application is similar to the selected software application based on the similarity score.

3. The method of claim 2, wherein determining that the sponsored application is similar to the selected software application based on the similarity score comprises:
comparing the similarity score to a threshold value; and
determining that the sponsored application is similar to the selected software application based on the comparison of the similarity score to the threshold value.

4. The method of claim 2, wherein the selected software application is associated with a selected application record in an application data store, wherein the sponsored application is associated with a sponsored application record in the application data store, wherein the selected application record and the sponsored application record include data related to the selected software application and the sponsored application, respectively, and wherein determining the similarity score comprises:
comparing the sponsored application record to the selected application record; and
determining the similarity score based on the comparison of the sponsored application record to the selected application record.

5. The method of claim 4, wherein the selected application record includes text that describes the selected software application, wherein the sponsored application record includes text that describes the sponsored application, wherein comparing the sponsored application record to the selected application record comprises detecting one or more text matches between the text of the selected application record and the text of the sponsored application record, and wherein determining the similarity score based on the comparison comprises determining the similarity score based on the one or more detected text matches.

6. The method of claim 4, wherein the selected application record includes a category associated with the selected software application, wherein the sponsored application record includes a category associated with the sponsored application, wherein comparing the sponsored application record to the selected application record comprises determining whether the category associated with the selected software application is similar to the category associated with the sponsored application, and wherein determining the similarity score based on the comparison comprises determining the similarity score based on whether the category associated with the selected software application is similar to the category associated with the sponsored application.

7. The method of claim 1, wherein determining that the sponsored application is similar to at least one of the N software applications comprises:
selecting one of the N software applications, wherein the selected software application is associated with a selected application record in an application data store, wherein the sponsored application is associated with a sponsored application record in the application data store, and wherein the selected application record and the sponsored application record include data related to the selected software application and the sponsored application, respectively;
comparing the sponsored application record to the selected application record; and
determining that the sponsored application is similar to the selected software application based on the comparison of the sponsored application record to the selected application record.

8. The method of claim 1, wherein determining that the sponsored application is similar to at least one of the N software applications comprises:
selecting one of the N software applications;
detecting one or more text matches between text associated with the selected software application and text associated with the sponsored application; and
determining that the sponsored application is similar to the selected software application based on the one or more detected text matches.

9. The method of claim 1, wherein determining that the sponsored application is similar to at least one of the N software applications comprises:
selecting one of the N software applications;
determining whether a category associated with the selected software application is similar to a category associated with the sponsored application; and
determining that the sponsored application is similar to the selected software application based on whether the category associated with the selected software application is similar to the category associated with the sponsored application.

10. The method of claim 1, wherein determining that the sponsored application is similar to at least one of the N software applications comprises:
selecting one of the N software applications; and
determining that the sponsored application is similar to the selected software application based on whether one or more users have previously selected the selected software application and the sponsored application from one or more of software application search results responsive to a software application search query and a list of software applications grouped by one or more categories.

11. The method of claim 1, wherein determining that the sponsored application is similar to at least one of the N software applications comprises:
selecting one of the N software applications; and
determining that the sponsored application is similar to the selected software application based on a similarity lookup table that indicates that the selected software application and the sponsored application are similar.

12. The method of claim 1, wherein identifying the advertisement record comprises determining that the sponsored application of the identified advertisement record is similar to multiple ones of the N software applications identified during the search.

13. The method of claim 1, wherein the advertisement content in the identified advertisement record includes at least one of text associated with the sponsored application and an image associated with the sponsored application, and wherein the generated advertisement comprises at least one of the text associated with the sponsored application and the image associated with the sponsored application.

14. The method of claim 1, wherein the identified advertisement record defines a condition for advertising the sponsored application, wherein the condition is satisfied when the sponsored application is similar to one or more software applications listed in a set of software application search results, and wherein identifying the advertisement record further comprises determining that the condition is satisfied in response to determining that the sponsored application of the identified advertisement record is similar to at least one of the N software applications identified during the search.

15. The method of claim 14, wherein the condition is a first condition, wherein the identified advertisement record further defines a second condition for advertising the sponsored application, wherein the first condition and the second condition are different, wherein the first condition and the second condition are part of a Boolean function, and wherein identifying the advertisement record further comprises determining that the Boolean function is satisfied.

16. The method of claim 15, wherein the second condition is satisfied when the sponsored application is dissimilar to one or more software applications listed in the set of software application search results, and wherein identifying the advertisement record further comprises determining that the second condition is satisfied in response to determining that the sponsored application of the identified advertisement record is dissimilar to at least one of the N software applications identified during the search.

17. The method of claim 1, further comprising:
receiving advertisement data from an advertiser device, the advertisement data indicating a name of a sponsored application and including advertisement content for the sponsored application; and
generating a new advertisement record in the advertisement data store based on the received advertisement data, wherein the new advertisement record lists the name of the sponsored application indicated by the advertisement data, and wherein the new advertisement record includes the advertisement content included in the advertisement data.

18. The method of claim 1, further comprising:
receiving advertisement data from an advertiser device, the advertisement data including a condition for advertising a new sponsored application, wherein the condition is satisfied when the new sponsored application is similar to one or more software applications listed in a set of software application search results; and
generating a new advertisement record in the advertisement data store based on the received advertisement data, wherein the new advertisement record includes the condition for advertising the new sponsored application.

19. A system comprising:
an advertisement data store that includes one or more advertisement records, each advertisement record listing a sponsored application associated with the advertisement record and including advertisement content for the sponsored application; and
one or more computing devices configured to:
receive a search query from a user computing device;
perform a search for software applications using the search query;
generate a list of N software applications identified during the search, wherein N is an integer greater than or equal to 1;
identify an advertisement record in the advertisement data store by determining that the sponsored application of the identified advertisement record is similar to at least one of the N software applications identified during the search;
generate an advertisement for the sponsored application based on the advertisement content in the identified advertisement record; and
transmit the list of the N software applications and the generated advertisement to the user computing device.

20. The system of claim 19, wherein to determine that the sponsored application is similar to at least one of the N software applications, the one or more computing devices are configured to:
select one of the N software applications;
determine a similarity score that indicates an amount of similarity between the sponsored application and the selected software application; and
determine that the sponsored application is similar to the selected software application based on the similarity score.

21. The system of claim 20, wherein the selected software application is associated with a selected application record in an application data store, wherein the sponsored application is associated with a sponsored application record in the application data store, wherein the selected application record and the sponsored application record include data related to the selected software application and the sponsored application, respectively, and wherein to determine the similarity score the one or more computing devices are configured to:
compare the sponsored application record to the selected application record; and
determine the similarity score based on the comparison of the sponsored application record to the selected application record.

22. The system of claim 19, wherein to determine that the sponsored application is similar to at least one of the N software applications, the one or more computing devices are configured to:
select one of the N software applications, wherein the selected software application is associated with a selected application record in an application data store, wherein the sponsored application is associated with a sponsored application record in the application data store, and wherein the selected application record and the sponsored application record include data related to the selected software application and the sponsored application, respectively;
compare the sponsored application record to the selected application record; and
determine that the sponsored application is similar to the selected software application based on the comparison of the sponsored application record to the selected application record.

23. The system of claim 19, wherein the identified advertisement record defines a condition for advertising the sponsored application, wherein the condition is satisfied when the sponsored application is similar to one or more software applications listed in a set of software application search results, and wherein to identify the advertisement record, the one or more computing devices are further configured to determine that the condition is satisfied in response to determining that the sponsored application of the identified advertisement record is similar to at least one of the N software applications identified during the search.

24. The system of claim 19, wherein the one or more computing devices are further configured to:
receive advertisement data from an advertiser device, the advertisement data indicating a name of a sponsored application and including advertisement content for the sponsored application; and
generate a new advertisement record in the advertisement data store based on the received advertisement data, wherein the new advertisement record lists the name of the sponsored application indicated by the advertisement data, and wherein the new advertisement record includes the advertisement content included in the advertisement data.

25. The system of claim 19, wherein the one or more computing devices are further configured to:
receive advertisement data from an advertiser device, the advertisement data including a condition for advertising a new sponsored application, wherein the condition is satisfied when the new sponsored application is similar to one or more software applications listed in a set of software application search results received by the one or more computing devices; and
generate a new advertisement record in the advertisement data store based on the received advertisement data, wherein the new advertisement record includes the condition for advertising the new sponsored application.

26. A non-transitory computer-readable storage medium comprising instructions that cause one or more computing devices to:
receive a search query from a computing device;
perform a search for software applications using the search query;
generate a list of N software applications identified during the search, wherein N is an integer greater than or equal to 1;
identify an advertisement record in an advertisement data store, wherein the advertisement data store includes one or more advertisement records, each advertisement record listing a sponsored application associated with the advertisement record and including advertisement content for the sponsored application, wherein the instructions that cause the one or more computing devices to identify the advertisement record comprise instructions that cause the one or more computing devices to determine that the sponsored application of the identified advertisement record is similar to at least one of the N software applications identified during the search;
generate an advertisement for the sponsored application based on the advertisement content in the identified advertisement record; and
transmit the list of the N software applications and the generated advertisement to the computing device.
